(19) United States
(12) Patent Application Publication
(10) Pub. No.: US 2020/0330989 A1
(43) Pub. Date: Oct. 22, 2020

(54) PARTICLE CAPTURING CHAMBER, PARTICLE CAPTURING CHIP, PARTICLE CAPTURING METHOD, APPARATUS, AND PARTICLE ANALYSIS SYSTEM

(71) Applicant: Sony Corporation, Tokyo (JP)

(72) Inventors: Shin Masuhara, Tokyo (JP); Kensuke Kojima, Kanagawa (JP); Hiroyuki Hosokawa, Kanagawa (JP); Yoshiaki Kato, Gunma (JP); Marcaurele Brun, Tokyo (JP); Toshio Watanabe, Kanagawa (JP)

(73) Assignee: Sony Corporation, Tokyo (JP)

(21) Appl. No.: 16/643,234

(22) PCT Filed: Sep. 6, 2018
(86) PCT No.: PCT/JP2018/033082

§ 371 Date: Feb. 28, 2020

(30) Foreign Application Priority Data
Sep. 7, 2017 (JP) 2017-171921
Mar. 19, 2018 (JP) 2018-050507

(51) Int. Cl. B01L 3/00; G01N 15/14

(52) U.S. Cl. CPC B01L 3/502761; B01L 3/50273; G01N 15/1404; B01L 2300/0864; B01L 2400/049; B01L 2200/16; B01L 2200/0668

(57) ABSTRACT

There is provided a microfluidic device for capturing particles comprising a particle capturing chamber (100) including at least: a particle capturing unit (101) including one of at least one well (106) or at least one through hole (108); and a particle capturing channel unit (102) used for capturing a particle in the well or with the through hole, in which the particle is captured in the well or with the through hole by being sucked, via the particle capturing channel unit, in a direction opposite to a direction (114) on which the particle settles. Such a configuration has for result that the particles that are not captured in the well or with the through hole are prevented from staying in the vicinity of the well or the through hole of the particle capturing unit when suction is stopped.

### CROSS REFERENCE TO RELATED APPLICATIONS

This application claims priority to Japanese Priority Patent Application JP 2017-171921 filed Sep. 7, 2017, and to Japanese Priority Patent Application JP 2018-050507 filed Mar. 19, 2018, the entire contents of each of which are incorporated herein by reference.

### TECHNICAL FIELD

The present disclosure relates to a particle capturing chamber, a particle capturing chip, a particle capturing method, an apparatus, and a particle analysis system. More specifically, the present disclosure relates to a particle capturing chamber including one of a well and a through hole, a particle being captured in the well or with the through hole by suction, a particle capturing chip including one of a well and a through hole, a particle being captured in the well or with the through hole by suction, a particle capturing method including capturing a particle in a well or with a through hole by suction, an apparatus including the particle capturing chamber, and a particle analysis system including the particle capturing chamber.

### BACKGROUND ART

Attention is drawn to a single cell analysis technology. In the single cell analysis technology, cells can be captured one by one in each of a large number of microwells arrayed in a plane, and the form of each cell can be individually observed to analyze characteristics of the cell and/or reaction of each cell to a reagent can be analyzed using, for example, fluorescence or the like as an index.

Examples of a commercially available apparatus used in the single cell analysis technology include an AS ONE Cell Picking System (manufactured by AS ONE Corporation). In an analysis technology using this apparatus, a cell suspension is applied to a microchamber including a large number of wells having a size to receive one cell, and one cell is allowed to settle in each of the wells. The one cell in each of the wells is then individually collected and/or analyzed. The wells are provided in a chip in the microchamber. As the chip, a plurality of types of chips matching the cell size are prepared. For example, a chip (including approximately 80,000 wells) in which wells of φ30 μm are arrayed at a pitch of 80 μm in an X direction and a Y direction, a chip (including approximately 300,000 wells) in which wells of φ10 μm are arrayed at a pitch of 30 μm in the X direction and the Y direction, and the like are prepared. With this apparatus, characteristics of cells individually isolated in the wells are observed by means of fluorescence detection or the like. The cells of interest are then extracted from the wells by a micromanipulator and transferred to a 96-well/384-well plate. Then, the cells can be subjected to more detailed analysis such as sequencing.

In addition, examples of the technology for capturing one cell in a well include the technology disclosed in Japanese Patent Application Laid-open No. 2011-163830. Japanese Patent Application Laid-open No. 2011-163830 discloses a micro fluid device capable of capturing circulation tumor cells (CTC) contained in a blood sample by a size-selective micro cavity array, which includes: an upper member formed with a sample inlet, a sample outlet, and a micro channel connecting between the sample inlet and the sample outlet and provided with an opening window for the size-selective micro cavity array at a position corresponding to a part of the micro channel; a micro cavity array support part consisting of the size-selective micro cavity array, having fine through holes for capturing CTC of which hole diameter, hole number and placement are controlled, and a tight seal for supporting the size-selective micro cavity array at a position corresponding to a lower side of the opening window; and a lower member which is formed with a suction opening window, provided at a position corresponding to a lower side of the size-selective micro cavity array, and a suction channel communicating the suction opening window and a suction opening.

### CITATION LIST

### Patent Literature

PTL 1: Japanese Patent Application Laid-open No. 2011-163830

### SUMMARY

### Technical Problem

In the commercially available apparatus described above, cells are expected to settle and enter the wells. The possibility that only one cell enters one well is considered to follow the probability theory of Poisson distribution. For example, in the case where cells whose number is the same as the number of wells are applied to the chip, it is unlikely that not less than 50% of the applied cells enter the wells, and many wells without cells can be observed. Further, since the cells simply settle, a plurality of cells often enter one well.

In Japanese Patent Application Laid-open No. 2011-163830, a technology for capturing cells in wells one by one has been proposed. In the technology, wells each include a hole, and cells are captured by suction through the respective holes. With this technology, it is possible to more efficiently capture cells in the wells. However, in the case where cells whose number is larger than that of wells are applied, for example, cells that are not captured in the wells settle in the vicinity of the wells. The cells settled in the vicinity of the wells can have adverse effects in the case when observing and/or monitoring the cells captured in the wells or when taking out the cells captured in the wells by using an apparatus such as a micromanipulator.

In order to remove the cells that have settled in the vicinity of the wells, it is conceivable to, for example, flush these cells. However, even in the case where flow to flush these cells is formed, the flow velocity becomes substantially zero on the surface of the chip on which the wells are provided, so that a somewhat high flow velocity is demanded to flush the settled cells. Meanwhile, in the case where the flow velocity of the flow formed to flush the settled cells is too high, the cells captured in the wells in the vicinity of the settled cells get out of the wells, or the cells captured in the wells are damaged in some cases. Thus, it is not easy to remove the cells settled in the vicinity of wells.

Further, in order to solve the above-mentioned problem, it is conceivable to apply cells whose number is smaller than that of wells. However, in this case, because flow due to suction is hardly formed in the vicinity of wells that have captured cells, cells can still settle in the vicinity of the wells that have captured cells. In addition, cells further settle in the wells that have captured the cells in some cases.

According to an embodiment of the present disclosure, there is provided a new single particle capturing technology.

### Solution to Problem

The inventors of the present disclosure have found that at least one of the abovementioned problems can be solved by using a specific particle capturing chamber.

According to some aspects, a method of separating particles is provided, the method comprising applying fluid pressure through a particle capturing chamber, the particle capturing chamber comprising a particle capturing unit dividing the particle capturing chamber into at least a first chamber and a second chamber and comprising a plurality of wells connected to the first chamber each including at least one through hole connected to the second chamber, wherein the fluid pressure is applied from the first chamber through the through holes of the plurality of wells and into the second chamber, thereby producing fluid flow in a first direction within the through holes, and wherein at least one force acts upon the particle capturing chamber in a direction that at least partially opposes the first direction.

In some embodiments, the second chamber is arranged above the first chamber, and wherein the at least one force includes a settling force.

In some embodiments, the at least one force includes one or more of: gravity, a centrifugal force produced by rotation of the particle capturing chamber and an electromagnetic force produced by an electric field.

In some embodiments, applying the fluid pressure comprises applying a differential pressure between an inlet and an outlet of the particle capturing chamber.

In some embodiments, the method further comprises a step of supplying a fluid comprising particles into the first chamber of the particle capturing chamber and capturing particles of the fluid in one or more wells of the plurality of wells.

In some embodiments, the method further comprises supplying a reagent fluid into the first chamber of the particle capturing chamber, thereby bringing the reagent fluid into contact with at least some of the captured particles in the one or more wells.

In some embodiments, the fluid pressure applied from the first chamber through the through holes of the plurality of wells and into the second chamber is a first fluid pressure, and the method further comprises analyzing the captured particles in the one or more wells whilst applying a second fluid pressure from the first chamber through the through holes of the plurality of wells and into the second chamber, the second fluid pressure being lower than the first fluid pressure.

In some embodiments, the method further comprises, subsequent to the step of applying fluid pressure from the first chamber through the through holes of the plurality of wells and into the second chamber, ceasing applying said fluid pressure and discharging fluid from the first chamber via a fluid discharge channel.

In some embodiments, the method further comprises applying suction to the wells from the second chamber during said discharge of fluid from the first chamber via the fluid discharge channel, thereby holding particles in the wells during said discharge.

In some embodiments, the direction of the at least one force forms an angle of at least 160 degrees with the first direction.

In some embodiments, the fluid pressure applied from the first chamber through the through holes of the plurality of wells and into the second chamber is applied for a predetermined amount of time, the predetermined amount of time being selected based on a diameter of particles to be captured within the plurality of wells.

According to some aspects, a microfluidic device for separating particles is provided, the microfluidic device comprising a particle capturing chamber comprising a particle capturing unit dividing the particle capturing chamber into at least an upper chamber and a lower chamber and comprising a plurality of wells connected to the lower chamber each including at least one through hole connected to the upper chamber, and at least one fluid port configured to receive fluid into the lower chamber and direct the fluid through the through holes of the plurality of wells into the upper chamber, thereby producing fluid flow in a first direction within the through holes, wherein the particle capturing chamber is configured to be oriented during operation of the microfluidic device to separate particles such that there is at least one force acting upon the particle capturing chamber in a direction that at least partially opposes the first direction.

In some embodiments, the at least one force includes a settling force.

In some embodiments, the settling force is selected from the group consisting of gravity, a centrifugal force produced by a rotation of the particle capturing chamber and an electromagnetic force produced by an electric field.

In some embodiments, the plurality of wells are arranged on a side of the particle capturing unit facing the first chamber.

In some embodiments, each of the plurality of wells has an opening facing the first chamber and an interior surface through which a respective through hole is formed, and wherein the opening is wider than the through hole.

In some embodiments, the through holes of the plurality of wells have a width between 1 μm and 10 μm.

In some embodiments, the direction of the at least one force forms an angle of at least 160 degrees with the first direction.

According to some aspects, a microfluidic system for separating particles is provided, the microfluidic system comprising a particle capturing chamber comprising a particle capturing unit dividing the particle capturing chamber into at least an upper chamber and a lower chamber and comprising a plurality of wells connected to the lower chamber each including at least one through hole connected to the upper chamber, and at least one fluid port configured to receive fluid into the lower chamber and direct the fluid through the through holes of the plurality of wells into the upper chamber, thereby producing fluid flow in a first direction within the through holes, wherein the particle capturing chamber is configured to be oriented during operation of the microfluidic system to separate particles such that there is at least one force acting upon the particle capturing chamber in a direction that at least partially opposes the first direction, and at least one pressure source coupled to the at least one fluid port and configured to apply fluid pressure to fluid within the lower chamber.

In some embodiments, the at least one force comprises one or more of: gravity, a centrifugal force produced by a rotation of the particle capturing chamber and an electromagnetic force produced by an electric field.

### Advantageous Effects of Invention

According to the present disclosure, there is provided a new technology for capturing one particle in one well or with one through hole. With the present disclosure, it is possible to more efficiently capture one particle in one well or with one through hole. It should be noted that the effect exerted by the present disclosure is not limited to the effect described here and may be any effect described in the present specification.

### BRIEF DESCRIPTION OF DRAWINGS

FIG. 1 is a schematic diagram showing an example of a particle capturing chamber according to an embodiment of the present disclosure and a state of capturing particles by using the chamber.

FIG. 2 is a schematic diagram showing an example of the particle capturing chamber according to the embodiment of the present disclosure and a state of capturing particles by using the chamber.

FIG. 3 is a schematic diagram showing an example of the particle capturing chamber according to the embodiment of the present disclosure and a state of discharging particles that are not captured in wells.

FIG. 4 is a schematic diagram showing an embodiment in which two particle capturing chambers according to the embodiment of the present disclosure are connected to each other.

FIG. 5 is a schematic diagram showing an example of the particle capturing chamber according to the embodiment of the present disclosure and a state of capturing the particles by the chamber and observing the captured particles.

FIG. 6 is a schematic diagram showing an example of the inside of the particle capturing chamber according to the embodiment of the present disclosure.

FIG. 7 is a schematic diagram showing an example of the inside of the particle capturing chamber according to the embodiment of the present disclosure.

FIG. 8 is a schematic diagram showing an example of wells provided in the particle capturing chamber according to the embodiment of the present disclosure.

FIG. 9 is a schematic diagram showing an example of a particle capturing chip according to an embodiment of the present disclosure.

FIG. 10 is a flowchart showing an example of a particle capturing method according to an embodiment of the present disclosure.

FIG. 11 is a diagram showing another example of the particle capturing chamber according to the embodiment of the present disclosure.

FIG. 12 is a block diagram showing an example of an apparatus according to an embodiment of the present disclosure.

FIG. 13 is a schematic diagram showing a chamber of a comparative example 1.

FIG. 14 is a photograph showing a state of capturing cells on a particle capturing surface.

FIG. 15 is a photograph showing that other cells adhere to the cells captured in the wells.

FIG. 16 is a photograph showing a state of capturing cells on the particle capturing surface.

FIG. 17 is a schematic diagram showing an example of the particle capturing chamber according to the embodiment of the present disclosure and a state of capturing particles by using the chamber.

FIG. 18 is a diagram showing an example of a particle capturing unit constituting the particle capturing chamber according to the embodiment of the present disclosure.

FIG. 19 is a diagram showing an example of the particle capturing unit constituting the particle capturing chamber according to the embodiment of the present disclosure.

FIG. 20 is a diagram showing an example of the particle capturing unit constituting the particle capturing chamber according to the embodiment of the present disclosure.

FIG. 21 is a diagram showing an example of the particle capturing unit constituting the particle capturing chamber according to the embodiment of the present disclosure.

FIG. 22 is a schematic diagram showing an example of the particle capturing chamber according to the embodiment of the present disclosure.

FIG. 23 is a diagram showing an example of the particle capturing chip having a particle capturing area.

FIG. 24 is a diagram showing an example of a method of stacking a plurality of parts forming a chip holder for holding the particle capturing chip according to the embodiment of the present disclosure

FIG. 25 is a diagram showing an example of the parts constituting the chip holder.

FIG. 26 is a diagram showing an example of a state in which the particle capturing chamber according to the embodiment of the present disclosure captures particles.

FIG. 27 is a flowchart showing an example of the particle capturing method according to the embodiment of the present disclosure.

FIG. 28 is a diagram showing an example of an imaging method.

FIG. 29 is a configuration example of the apparatus according to the embodiment of the present disclosure.

FIG. 30 is a block diagram showing an example of a control unit.

### DESCRIPTION OF EMBODIMENTS

Hereinafter, favorable embodiments for carrying out the present disclosure will be described. Note that the embodiments described below illustrate only examples of typical embodiments of the present disclosure, and the scope of the present disclosure is not narrowly interpreted by the embodiments. Note that description will be made in the following order.

### 1. First Embodiment (Particle Capturing Chamber)

### (1) Description of First Embodiment

### (2) First Example of First Embodiment (Particle Capturing Chamber)

### (3) Second Example of First Embodiment (Particle Capturing Chamber)

### (4) Third Example of First Embodiment (Particle Capturing Chamber)

### (5) Fourth Example of First Embodiment (Particle Capturing Chamber)

### (6) Fifth Example of First Embodiment (Example of Particle Capturing Unit)

### (7) Sixth Example of First Embodiment (Example of Particle Capturing Unit)

### (8) Seventh Example of First Embodiment (Example of Well)

### (9) Eighth Example of First Embodiment (Particle Capturing Chamber)

### (10) Ninth Example of First Embodiment (Example of Well)

### (11) Tenth Example of First Embodiment (Example of Well)

### (12) Eleventh Example of First Embodiment (Example of Through Hole)

### (13) Twelfth Example of First Embodiment (Example of Through Hole)

### (14) Thirteenth Example of First Embodiment (Particle Capturing Chamber)

### (15) Fourteenth Example of First Embodiment (Particle Capturing Chamber)

### 2. Second Embodiment (Particle Capturing Chip)

### (1) Description of Second Embodiment

### (2) Example of Second Embodiment (Particle Capturing Chip)

(3) Another Example of Second Embodiment (Example of Chip and Chip holder)

### 3. Third Embodiment (Particle Capturing Method)

### (1) Description of Third Embodiment

### (2) First Example of Third Embodiment (Particle Capturing Method)

### (3) Second Example of Third Embodiment (Another Example of Particle Collecting Step)

### (4) Third Example of Third Embodiment (Particle Capturing Method)

### (5) Fourth Example of Third Embodiment (Example of Operation for Capturing Particles)

### (6) Fifth Example of Third Embodiment (Example of Entire Surface Observation at Low Magnification)

### (7) Sixth Example of Third Embodiment (Example of Three-Dimensional Observation at High Magnification) 4. Fourth Embodiment (Apparatus)

### (1) Description of Fourth Embodiment

### (2) Example of Fourth Embodiment (Apparatus)

### (3) Another Example of Fourth Embodiment (Apparatus)

### 5. Fifth Embodiment (Particle Analysis System)

### (1) Description of Fifth Embodiment

### (2) Example of Fifth Embodiment (Particle Analysis System)

### (3) Another Example of Fifth Embodiment (Particle Analysis System)

### 6. Example

(1) Comparative example 1

### (2) Example 1

### (3) Example 2

### 1. First Embodiment (Particle Capturing Chamber)

### (1) Description of First Embodiment

According to an embodiment of the present disclosure, there is provided a particle capturing chamber, including at least: a particle capturing unit including one of at least one well or at least one through hole; and a particle capturing channel unit used for capturing a particle in the well or with the through hole, in which the particle is captured in the well or with the through hole by being sucked, via the particle capturing channel unit, to a side opposite to a side on which the particle settles.

In the present disclosure, the particle is captured in the well or with the through hole by being sucked on the side opposite to the side on which the particle settles. In the case of capturing particles in a suction force operative portion such as the well and the through hole by sucking the particles to the side opposite to the side on which the particles settle, particles that are not captured in the well or with the through hole settle to a direction, e.g., the action direction of gravity, different from the movement direction of particles by the suction force. As a result, the effects that the particles that are not captured in the well or with the through hole are prevented from staying in the vicinity of the well or the through hole of the particle capturing unit and/or another particle is prevented from entering the well that has captured a particle or the through hole that has captured a particle is prevented from capturing another particle are exerted.

Further, in the present disclosure, since a cell is caused to move into the well or an entrance of the through hole by a suction force, the possibility that one particle is captured in one well is increased as compared with the case of simply expecting that a cell settles to enter the well. According to the present disclosure, for example, it is possible to capture, in the case where particles whose number is the same as that of wells or through holes are applied to the chip, not less than 50% of the applied particles one by one in the wells or with the through holes. Further, according to the present disclosure, the particles that are not captured in the well or with the through hole are prevented from staying in the vicinity of the well or the through hole of the particle capturing unit and/or another particle is prevented from entering the well that has captured a particle or the through hole that has captured a particle is prevented from capturing another particle while increasing the possibility that one particle is captured in one well or with one through hole.

Further, as described above, in the present disclosure, the particles that are not captured in the well or with the through hole are prevented from staying in the vicinity of the well or the through hole of the particle capturing unit and/or the well or through hole that has captured a particle is prevented from capturing another particle. Therefore, it is possible to perform better observation and/or monitoring of the particle captured in the well or with the through hole. In addition, it is possible to reduce the possibility that taking out of the particles captured in the well or with the through hole therefrom is affected by particles that are not captured in the well or with the through hole.

Further, according to the present disclosure, it is possible to perform single particle capturing with a simple configuration. Therefore, it is also possible to reduce the cost of apparatus for capturing particles.

Further, as described above, according to the present disclosure, the particles that are not captured in the well or with the through hole are prevented from staying in the vicinity of the well or the through hole of the particle capturing unit. For example, the particles that are not captured in the well or with the through hole settle on the bottom surface of the chamber. For that reason, the distance between the particle captured in the well or with the through hole and the particle that is not captured is large. Therefore, for example, in the case of observing, by a microscope, the particle captured in the well or with the through hole, by focusing on this particle, the particles that are not captured in the wells or with the through holes are not brought into focus and not observed. Specifically, it is possible to observe the particle captured in the well or with the through hole, without performing the step of removing the particles that are not captured in the wells or with the through holes.

For similar reasons, it is also possible to take out the particles captured in the wells or with the through holes, without performing a step of removing the particles that are not captured in the wells or with the through holes.

Further, in the case of removing the particles that are not captured in the wells or with the through holes, since the distance between the particle captured in the well or with the through hole and the particle that is not captured is large, it is possible to flush the particles that are not captured in the wells or with the through holes with flow of a higher flow velocity. In addition, it is possible to reduce the possibility that the particles captured in the wells or with the through holes get out of the wells by the flow or are away from the through holes and/or the particles are damaged by the flow.

In the present disclosure, the particle capturing unit includes one of at least one well and at least one through hole for capturing a particle. The particle capturing unit may be provided inside the particle capturing chamber according to the embodiment of the present disclosure.

In the present disclosure, in the case where the particle capturing unit includes a well, a particle is moved to the side opposite to the side on which the particle settles in the chamber by suction, floats in the chamber, and is then captured in the well. Further, in the present disclosure, in the case where the particle capturing unit includes a through hole, a particle is moved to the side opposite to the side on which the particle settles in the chamber by suction, floats in the chamber, and is then captured with the through hole so as to block at least a part of one of two ports of the through hole penetrating the particle capturing unit, for example.

Specifically, the particle capturing unit can be provided in the particle capturing chamber so that such movement and capturing of the particle can be performed. The lower limit of the number of wells or through holes can be, for example, 1, particularly 10, more particularly 100, and even more particularly 1,000. The upper limit of the number of wells or through holes can be, for example, 1,000,000, particularly 800,000, more particularly 600,000, and more particularly 500,000. The range of the number of wells or through holes may be a range determined by values selected from any of the above-mentioned lower limit values and any of the above-mentioned upper limit values, and can be, for example, 1 to 1,000,000, particularly 10 to 800,000, more particularly 100 to 600,000, and even more particularly 1,000 to 500,000.

In the present disclosure, the particle capturing channel unit may be a channel used when capturing a particle in the well or with the through hole, or a part including the channel. By suction via the channel, the particle is moved in the chamber, and is then captured in the well or with the through hole.

In the present disclosure, “sucking to the side opposite to the side on which the particle settles” represents, for example, sucking particles in such a way that the particles are moved in a direction opposite to at least one component of a force that is different than the fluid force(s) which cause the particles to move. In some cases, the direction of the force may be opposite to a direction of fluid flow through a through hole—that is, the fluid force(s) that cause the particles to move may be in the same direction as the direction of fluid flow through the through hole.

In some cases, particles may be moved in a direction opposing the action direction of gravity on the particles inside the chamber with which the well is in contact or space inside the chamber with which a port (port on the side on which the particle settles) with which a particle is captured is in contact among the two ports of the through hole. In other instances, particles may be moved in a direction that partially opposes the force of gravity—that is, where the particles are not moved in the opposite direction to the action direction of gravity, but where the particles' motion is opposite to at least a component of the force of gravity. Irrespective of whether the force other than the fluid force(s) causing the particles to move is that of gravity or some other force, the motion direction of the particles through the wells and/or through holes due to fluid force(s) may be directed at an angle with respect to the direction of the force other than the fluid force(s) that is at least 90 degrees, for example, at least 120 degrees, favorably at least 135 degrees, more favorably at least 150 degrees, and even more favorably at least 160 degrees.

In some cases, the settling may be settling by, for example, a centrifugal force. In the case where the settling is settling by a centrifugal force, “sucking to the side opposite to the side on which the particle settles” represents, for example, sucking particles in such a way that the particles are moved to the direction opposite to the action direction of centrifugal force on the particles in space inside the chamber with which the well is in contact or space inside the chamber with which a port with which a particle is captured is in contact among the two ports of the through hole. The particles may be sucked in such a way that the motion direction of the particles through the wells and/or through holes due to fluid force(s) may be directed at an angle with respect to the direction of the centrifugal force that is at least 90 degrees, for example, at least 120 degrees, favorably at least 135 degrees, more favorably at least 150 degrees, and even more favorably at least 160 degrees.

In some cases, the particles may be sucked in such a way that the motion direction of the particles through the wells and/or through holes due to fluid force(s) may at least partially oppose an electrokinetic force applied to the particles. For instance, at least some of the particles may be charged and an electrokinetic force applied to the particles via an electric field.

In the present disclosure, “the side on which the particle settles” represents, for example, the side of the space inside the chamber with which the well is in contact or the side of the space inside the chamber with which a port with which the particle is captured among the two ports of the through hole, of a plurality of (e.g., two) spaces inside the chamber divided by the particle capturing unit.

Further, in the present disclosure, “the side opposite to the side on which the particle settles” represents, for example, the side opposite to the side of the space inside the chamber with which the well is in contact or the side opposite to the side of the space inside the chamber with which a port with which the particle is captured is in contact among the two ports of the through hole, of the plurality of spaces inside the chamber divided by the particle capturing unit, and represents, for example, the side of the space inside the chamber closer to the particle capturing channel unit.

In the present disclosure, the suction may be performed by an arbitrary means known to those skilled in the art, and can be performed by using a pump, for example. As the pump, a commercially available one may be used. The type of the pump can be appropriately selected by those skilled in the art depending on, for example, the suction force to be applied.

In the present disclosure, the particle capturing chamber represents a structure having a space for capturing a particle in the well or with the through hole. The particle capturing unit can be provided in this space.

In the present disclosure, the particles are desired to be captured one by one, for example. Examples of the particles include, but not limited to, biological microparticles such as cells, microorganisms, biological solid components, and liposomes, and synthetic particles such as latex particles, gel particles, and industrial particles. Examples of the cells include animal cells and plant cells. Examples of the animal cells include tumor cells and blood cells. Examples of the microorganisms include bacteria such as Escherichia coli, and Fungi such as yeast. Examples of the biological solid components include solid matter crystals produced in a living body. Examples of the synthetic particles include particles formed of organic or inorganic polymer materials or metals. Examples of the organic polymer materials include polystyrene, styrene-divinylbenzene, and polymethyl methacrylate. Examples of the inorganic polymer materials include glass, silica, and magnetic materials. Examples of the metal include gold colloid and aluminum. Further, in the present disclosure, the particle may be a combination of a plurality (e.g., two or three) of particles.

In a favorable embodiment of the present disclosure, the well may include a hole. The well and the particle capturing channel unit may be communicated with each other via the hole. Specifically, the hole penetrates the particle capturing unit from the well side to the particle capturing channel unit side. By performing suction via the particle capturing channel unit through the hole, particles can be captured in the wells. The number of holes provided in each well can be, for example, 1 to 10, particularly 1 to 5, and more particularly 1 to 3. From the viewpoint of ease of production, the number of holes provided in each well can be 1 or 2, particularly 1.

In the present disclosure, as the shape of the entrance of the hole, arbitrary shape may be adopted. In the present disclosure, the entrance of the hole represents an opening of the hole on the well wall surface in which the hole is provided. The shape of the entrance of the hole can be, for example, a circle, an ellipse, or a polygon such as a triangle, a tetragon (e.g., a rectangle, a square, a parallelogram, and a rhombus), a pentagon, and a hexagon. In the present disclosure, the shape of the entrance of the hole can be favorably a tetragon, more favorably a rectangle or a square, and even more favorably, a rectangle.

In the present disclosure, the entrance of the hole can have a dimension that prevents the particle to be captured from passing through the hole by suction to reach the particle capturing channel unit. For example, the minimum dimension of the entrance of the hole is less than the dimension of the particle.

For example, in the case where the shape of the entrance of the hole is a rectangle, the short side or the long side of the rectangle, particularly the short side of the rectangle can have a dimension smaller than the dimension (diameter of the particle or the like) of the particle to be captured. For example, the length of the short side of the rectangle can be, for example, not more than 0.9 times, particularly not more than 0.8 times, more particularly not more than 0.7 times, even more particularly not more than 0.6 times the dimension (e.g., diameter of the particle) of the particle to be captured. There is also a need to set the length of the short side of the rectangle so as not to affect the suction, and the length of the short side of the rectangle can be set to, for example, not less than 0.01 times, particularly not less than 0.1 times, and even more particularly not less than 0.3 times the dimension of the particle to be captured.

For example, in the case where the shape of the entrance of the hole is a circle, the hole can have a diameter smaller than the dimension (e.g., diameter of the particle, or the like) of the particle to be captured. For example, the diameter of the circle can be no more than 0.8 times, particularly no more than 0.7 times, and even more particularly no more than 0.6 times the dimension (e.g., diameter of the particle) of the particle to be captured. There is also a need to set the diameter so as not to affect the suction, and the diameter can be set to, for example, not less than 0.01 times, particularly no less than 0.1 times, and even more particularly no less than 0.3 times the dimension of the particle to be captured.

With such a shape of the hole, it is possible to capture particles while preventing the particles from being damaged.

In the present disclosure, the shape of the entrance of the hole is favorably a rectangle. The length of the long side of the rectangle can favorably be not less than 1.2 times, more favorably not less than 1.3 times, even more favorably not less than 1.5 times the length of the short side of the rectangle. Further, the length of the long side of the rectangle can favorably be, for example, not more than 5 times, more favorably not more than 4 times, more favorably not more than 3 times, and even more favorably not more than 2.5 times the length of the short side of the rectangle. With such a slit shape, it is possible to suppress the damage of particles when the particles are captured in the wells. Such a slit shape is particularly favorable in the case where the particle is a cell. Since the entrance of the hole has a slit shape, it is possible to suppress the damage of the cell while preventing the cell from passing through the hole.

For example, the shape of the entrance of the hole can be a slit shape having a short side of 1 μm to 10 μm, particularly 2 μm to 8 μm, and a long side of 5 μm to 20 μm, particularly 6 μm to 18 μm.

In the present disclosure, the hole may favorably be provided at the bottom of the well. In the case where the hole is provided at the bottom of the well, the length of the hole is shorter than that in the case where the hole is provided on the side surface of the well. As a result, it is possible to more easily perform production. The bottom of the well can be, for example, a wall on the side opposite to the opening of the well among the walls constituting the well.

From the viewpoint of workability, the hole is favorably shallower. Meanwhile, from the viewpoint of the strength of the particle capturing unit, the hole is preferably deeper. Therefore, in the present disclosure, in the case where the hole is provided at the bottom of the well, the depth (i.e., distance from the well bottom surface to the surface opposite to the particle capturing surface) of the hole is favorably 5 to 100 μm, more favorably 6 to 50 μm, and even more favorably 10 to 30 μm.

In the present disclosure, the well may be opened to a side on which the particle settles. Specifically, the port of the well may face the side on which the particle settles. With this configuration, particles that move in the chamber by being sucked to the side opposite to the side on which the particle settles are captured in the wells.

In the present disclosure, each of the wells may have such a shape that captures one particle. For example, the shape of the entrance of the well can be, for example, a circle, an ellipse, or a polygon such as a triangle, a tetragon (e.g., a rectangle, a square, a parallelogram, and a rhombus), a pentagon, and a hexagon. In the present disclosure, the entrance of the well represents the opening of the well on the surface of the particle capturing unit in which the well is provided. The shape of the entrance of the well can be designed so that, for example, the particle to be captured can enter the well but the particle that is not to be captured is not allowed to enter the well.

In another embodiment, the well can be shaped such that the inlet of the well is the narrowest and the inside of the well has a larger cross-sectional area. Such a shape makes it possible to prevent the particle that has entered the well from getting out of the well.

In still another embodiment, the well can be shaped such that the inlet of the well is the widest and the inside of the well has a smaller cross-sectional area. Such a shape allows the particle to more easily enter the well.

In the present disclosure, the through hole plays the same role as the hole. All of the description of the hole also applies to the through hole. For example, the description of the shape and the dimension of the entrance of the hole described above also applies to the description of the two ports (particularly, port with which a particle is captured among the two ports) of the through hole.

Further, the length (i.e., distance between the two ports) of the through hole may be the same as the thickness of the particle capturing unit, particularly the thickness of the plate-like part described below.

The shape of the through hole may be, for example, cylindrical, prismatic (e.g., triangular prismatic and quadrangular prismatic), or chevron. Alternatively, other shapes may be used.

For example, in the case where the shape of the through hole is a quadrangular prism shape, the shape of the port of the through hole on the particle capturing surface is a rectangle, and the rectangle may be continued to the surface opposite thereto. Further, in the case where the shape of the through hole is chevron, the side surface (i.e., inclined surface) of the through hole may be linear or curved (e.g., surface drawing an arc). In this case, the particles may be captured in the vicinity of the port of the through hole or in the middle of the through hole.

Further, other examples of the shape of the through hole include a shape such that the shape of the port of the through hole on the particle capturing surface is continued to the middle of the through hole and the cross-sectional area of the through hole is gradually reduced from the middle. Examples of such a shape include a microneedle shape.

The particle capturing unit used in the present disclosure has at least one surface including the well or the through hole. In the present disclosure, the surface including the well or the surface including the through hole (particularly, surface including the port on the side on which the particle settles among the two ports of the through hole) is referred to also as “particle capturing surface”. The particle capturing unit can be provided so that this surface faces the side on which the particle settles. Specifically, in an embodiment of the present technology, the particle capturing unit can have the particle capturing surface that faces the side on which the particle settles, and the well or the through hole can be provided in the particle capturing surface.

The particle capturing surface may be a flat surface or a curved surface. From the viewpoint of ease of production, the particle capturing surface is favorably a flat surface. In the case where the particle capturing surface is a flat surface, the particle capturing surface may be provided so that the flat surface is perpendicular to the action direction of gravity on the particle, or so that the flat surface forms an angle of less than 90 degrees with respect to the action direction.

In the present disclosure, the wells or the through holes may be regularly arranged on at least one surface of the particle capturing unit, i.e., the particle capturing surface. The regular arrangement of wells or through holes makes it possible to more easily identify the positions of the wells or the through holes in/with which target particles are captured. As a result, for example, it is possible to more easily take out the particles captured in the wells or with the through holes therefrom and/or more easily observe the particles. For example, the wells or the through holes can be arranged on the particle capturing surface in one line or a plurality of lines at predetermined intervals, or the wells or the through holes can be arranged in a lattice shape on the particle capturing surface at predetermined intervals. The interval can be appropriately selected by those skilled in the art depending on, for example, the number of particles to be applied, the number of particles to be captured, and the like. The interval can be, for example, 20 μm to 300 μm, favorably 30 μm to 250 μm, more favorably 40 μm to 200 m, and even more favorably 50 μm to 150 μm. For example, in the case where the wells or the through holes are arranged in a lattice shape, the wells or the through holes can be arranged in the X direction and the Y direction on the particle capturing surface at the above-mentioned intervals.

In the present disclosure, the particle capturing unit may be disposed to divide the inside of the chamber into a space on the side on which the particle settles and a space on the side opposite thereto. In this case, the particle capturing unit can be provided so that the particle capturing surface of the particle capturing unit faces the side on which the particle settles. Further, the particle capturing unit can have the surface facing the space on the opposite side.

In the present disclosure, in the case where the particle capturing unit includes the well, the hole provided in the well communicates with the surface facing the space on the opposite side. Specifically, the well and the space on the opposite side are communicated with each other via the hole. The space on the side on which the particle settles and the space on the opposite side may be communicated with each other via only the hole, or via the hole and another communication part. Favorably, the two spaces are communicated with each other via only the hole. With this configuration, the suction force acts on the particles more efficiently.

Further, in the present disclosure, in the case where the particle capturing unit includes the through hole, the through hole allows the two spaces inside the chamber divided by the particle capturing unit to communicate with each other. The space on the side on which the particle settles and the space on the opposite side may be communicated with each other via only the through hole, or via the through hole and another communication part. Favorably, the two spaces are communicated with each other via only the through hole. With this configuration, the suction force acts on the particles more efficiently.

In a favorable embodiment of the present disclosure, the particle capturing unit may include a plate-like part having a particle capturing surface facing the side on which the particle settles and a surface facing the opposite side. With this configuration, it is possible to more easily produce the particle capturing unit and more easily monitor and/or observe the captured particles. Further, the ratio of the volume of the particle capturing unit in the chamber is reduced, and the entire chamber can be miniaturized. The thickness of the plate-like part can be appropriately set by those skilled in the art depending on, for example, the depth of the well, the depth of the hole, the strength of the material of the plate-like part, and the like, or on the depth of the through hole, the strength of the material of the plate-like part, and the like. The thickness of the platelike part can be, for example, 10 μm to 1000 μm, favorably 15 μm to 500 μm, and more favorably 20 μm to 200 μm.

As the material of the particle capturing unit (particularly, material of the part in which the well or the through hole is formed), a material capable of forming the well or the through hole used in the present disclosure is favorable. Examples of such a material include ultraviolet curable resin, particularly resin applicable to a 3D stereolithography method. Examples of the apparatus used for the 3D stereolithography method include an ACCULAS (Trademark) stereolithography printer. The resin can be appropriately selected by those skilled in the art. The resin can be obtained by, for example, ultraviolet-curing a resin composition containing at least one of an acrylic oligomer, an acrylic monomer, an epoxy oligomer, and an epoxy monomer.

The material of another part of the particle capturing chamber according to the embodiment of the present disclosure may be appropriately selected by those skilled in the art. For example, in the case where the particles are cells, the material is favorably a material that is not toxic to the cells.

Further, in the case of performing fluorescence observation of the captured particles, it is favorable to use a material that does not emit autofluorescence above the allowable range.

Further, it is favorable to use a material that enables observation of the particles in the wells or the particles captured with the through hole. For observation of the particles, for example, at least a part of the chamber can be formed of a transparent material.

As the material of another part of the particle capturing chamber according to the embodiment of the present disclosure, for example, a material generally used in the technical field of micro channel can be used. Examples of the material include glass such as borosilicate glass and quartz glass, plastic resin such as acrylic resin, cycloolefin polymer, and polystyrene, and a rubber material such as PDMS. In the case where the particle capturing chamber according to the embodiment of the present disclosure includes a plurality of members, the plurality of members may be formed of the same material or different materials.

In the present disclosure, the particle capturing unit may be replaceable. Since the particle capturing unit is replaceable, it is possible to repeatedly use the part other than the particle capturing unit of the particle capturing chamber. The particle capturing chamber according to the embodiment of the present disclosure can be configured so that the particle capturing unit therein can be taken out therefrom. For example, the particle capturing chamber can include a removable lid. By removing the lid, the particle capturing unit can be replaced.

In a particularly favorable embodiment of the present disclosure, the particle capturing unit may be disposed to divide an inside of the chamber into a space on the side on which the particle settles and a space on the side opposite to the side on which the particle settles, and the two spaces may be communicated with each other via the hole. The particle capturing unit allows the suction force to act on the particles more efficiently.

The particle capturing channel unit used in the present disclosure is used for capturing a particle in the well or with the through hole. The particle capturing channel unit is favorably connected to the space on the side opposite to the side on which the particle settles. With this configuration, suction is performed so that the particle is captured in the well or with the through hole via the particle capturing channel unit.

In the present disclosure, the particle capturing channel unit may be connected to a sucking unit. The sucking unit can perform the suction. The sucking unit can be, for example, a pump known to those skilled in the art. The pump used in the present disclosure is favorably a pump capable finely adjusting the suction force, more favorably a pump capable of controlling the pressure in the order of tens of Pa at around 1 kPa. Such a pump is commercially available, and examples of the pump include KAL-200 (Halstrup-Walcher Group). In some embodiments, it may be desirable to reduce the pressure as low as possible when sucking cells. Also, when expelling cells by applying positive pressure, a comparatively large amount of pressure may be applied. In some embodiments, the pressure when sucking cells may be greater than or equal to 5 Pa, 10 Pa, 20 Pa, 50 Pa, 75 Pa, or 100 Pa. In some embodiments, the pressure when sucking cells may be less than or equal to 500 Pa, 300 Pa, 200 Pa, 100 Pa, or 50 Pa. Any suitable combinations of the above-referenced ranges are also possible (e.g., a pressure when sucking cells of greater or equal to 20 Pa and less than or equal to 200 Pa, etc. with a preferred range of between 10 Pa and 100 Pa). In some embodiments, the pressure when expelling cells may be greater than or equal to 1 kPa, 5 kPa, 10 kPa, 20 kPa, or 30 kPa. In some embodiments, the pressure when expelling cells may be less than or equal to 50 kPa, 25 kPa, 15 kPa, 10 kPa, 5 kPa or 2 kPa. Any suitable combinations of the above-referenced ranges are also possible (e.g., a pressure when expelling cells of greater or equal to 5 kPa and less than or equal to 20 kPa, etc. with a preferred range of between 15 kPa and 30 kPa, such as 20 kPa).

In the present disclosure, the particle capturing channel unit can be used not only for capturing a particle in the well or with the through hole but also for discharging the particle captured in the well from the well or discharging the particle captured with the through hole from the through hole. For example, in the case where suction is performed by negative pressure, the discharge can be performed by applying positive pressure.

In the present disclosure, a second fluid supply channel unit may be connected to the space on the opposite side. By introducing fluid from the second fluid supply channel unit, it is possible to more efficiently replace the fluid in the chamber.

### (2) First Example of First Embodiment (Particle Capturing Chamber)

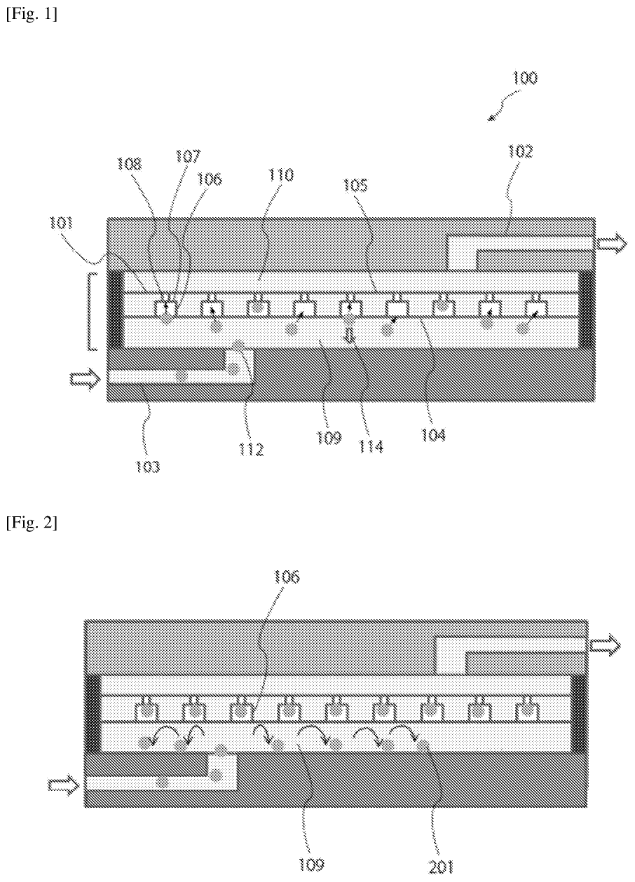

Hereinafter, an example of the particle capturing chamber according to the embodiment of the present disclosure and a state of capturing particles by using the chamber will be described with reference to FIG. 1 and FIG. 2. FIG. 1 and FIG. 2 are each a schematic diagram showing an example of the particle capturing chamber according to the embodiment of the present disclosure and a state of capturing particles by using the chamber.

In FIG. 1, a particle capturing chamber 100 includes a particle capturing unit 101, a particle capturing channel unit 102, and a fluid supply channel unit 103. The particle capturing unit 101 has a particle capturing surface 104 and a surface 105 facing the opposite side thereto. The particle capturing surface 104 includes a plurality of wells 106. A hole 108 is provided at a bottom 107 of each of the wells 106. The hole 108 extends from the bottom 107 of the well to the surface 105 opposite to the particle capturing surface. The particle capturing chamber 100 is disposed so that gravity acts on particles 112 in the direction indicated by an arrow 114. The wells 106 each have a dimension in which only one particle 112 is captured.

In FIG. 1, the space inside the particle capturing chamber 100 is divided by the particle capturing unit 101 into a space 109 on the side on which the particle settles and a space 110 on the side opposite thereto.

To the fluid supply channel unit 103, a container (not shown) for storing fluid containing the particles is connected. The fluid supply channel unit 103 supplies the fluid containing the particles to the chamber 100. The fluid supply channel unit 103 is connected to the space 109 on the side on which the particle settles, at the bottom (i.e., surface on which the particle settles) of the chamber 100. The fluid containing the particles is supplied from the container to the space 109 on the side on which the particle settles via the fluid supply channel unit 103.

Note that the fluid supply channel unit 103 may be connected to the space 109 on the side on which the particle settles, at a part other than the bottom of the chamber. For example, the fluid supply channel unit 103 may be provided to communicate with the space 109 on the side on which the particle settles, at the side surface of the chamber.

The suction is performed, via the particle capturing channel unit 102, by using a pump (not shown) connected to the particle capturing channel unit 102. The particle capturing channel unit 102 is connected to the space 110 on the opposite side, at the top (i.e., surface opposite to the surface on which the particle settles) of the chamber 100.

Note that the particle capturing channel unit 102 may be provided at a part other than the top of the chamber. For example, the particle capturing channel unit 102 may be provided to communicate with the space 110 on the opposite side, on the side surface of the chamber.

By performing suction using the pump, the fluid containing the particles is supplied from the container to the space 109 on the side on which the particle settles via the fluid supply channel unit 103. By further continuing the suction, the particles 112 float in the space 109 on the side on which the particle settles, and each enter any of the wells 106. The particle 112 that has entered any of the wells 106 strikes the entrance of the hole 108, and stops moving. This is because the dimension of the hole 108 is smaller than that of the particle 112, which prevents the particle 112 from passing through the hole 108. In this way, the particles are captured in the wells 106.

In particle capturing using the particle capturing chamber 100 shown in FIG. 1, since the particles 112 are guided into the wells 106 by suction, the possibility that the particles are captured in the wells is increased.

Further, an example of the movement of the particles that are not captured in the wells is shown in FIG. 2. As shown in FIG. 2, particles 201 that are not captured in the wells settle at the bottom of the space 109 on the side on which the particle settles by the action of gravity. As a result, the particles that are not captured do not stay in the vicinity of the wells 106.

Further, since the holes of the wells that have captured particles are blocked by the particles, other particles are prevented from entering the wells. In other words, it is possible to prevent other particles from entering the wells that have captured particles.

The particles captured in the wells can be observed and/or monitored in various ways. For example, by adding predetermined fluorescent labels to particles before supplying the particles to the chamber, it is possible to select a particle that emits the strongest fluorescence from the captured particles after the capturing. Further, it is possible to take out only the selected particle from the particle capturing chamber 100 by using a single particle obtaining apparatus such as a micromanipulator. Then, different processing can be performed using the selected particle. In the case where the particle is a cell, the different processing can be, for example, gene analysis, culturing, substance production, or the like.

With the above-mentioned series of operations, it is possible to select a particle having desired characteristics such as a cell secreting a desired antibody, a cell or microorganism expressing a desired gene, and a cell having a desired differentiation potency.

### (3) Second Example of First Embodiment (Particle Capturing Chamber)

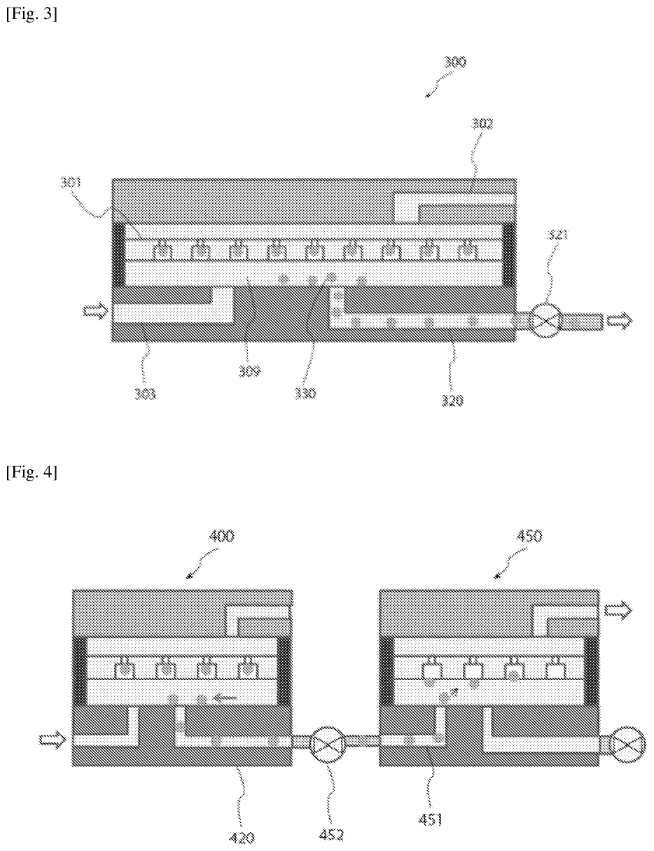

Another example of the particle capturing chamber according to the embodiment of the present disclosure will be described below with reference to FIG. 3. FIG. 3 is a schematic diagram showing the particle capturing chamber according to the embodiment of the present disclosure and discharging of the particles that are not captured in the wells.

A particle capturing chamber 300 described in FIG. 3 includes a particle capturing unit 301, a particle capturing channel unit 302, and a fluid supply channel unit 303. The particle capturing chamber 300 shown in FIG. 3 further includes a fluid discharge channel unit 320, and a valve 321 is connected to the fluid discharge channel unit 320.

The particle capturing using the particle capturing chamber 300 described in FIG. 3 may be performed in the same way as that in the particle capturing chamber 100 shown in FIG. 1, with the valve 321 closed. As a result of the particle capturing, as described with reference to FIG. 2, particles are captured in the wells, and particles that are not captured in the wells settle at the bottom of a space 309 on the side on which the particle settles, by the action of gravity.

After capturing the particles in the wells, the valve 321 is opened. Then, the particles that have settled at the bottom are discharged to the outside of the particle capturing chamber 300 via the fluid discharge channel unit 320 by suction using a pump (not shown) connected to the tip of the valve 321. Alternatively, instead of the pump, by means of liquid supply using a pump (not shown) connected to the fluid supply channel unit 303, the particles that have settled at the bottom may be discharged to the outside of the particle capturing chamber 300 via the fluid discharge channel unit 320.

In the particle capturing chamber according to the embodiment of the present disclosure, as described above, the distance between the particle captured in the well and the particle that is not captured in the well is large. Therefore, it is possible to reduce the possibility that the particle captured in the well gets out of the well and/or the particle is damaged when discharging the particles that are not captured in the wells. Further, it is possible to increase the speed of the flow formed when discharging the particles that are not captured in the wells as compared with the existing technology in which the particles that are not captured in the wells stay in the vicinity of the wells.

As described above with reference to FIG. 3, the particle capturing chamber according to the embodiment of the present disclosure may further include a fluid discharge channel unit that discharges fluid from the chamber. The fluid discharge channel unit may be connected to the space on the side on which the particle settles. The fluid discharge channel unit can be used for discharging that particles that are not captured in the wells to the outside of the particle capturing chamber, as described above. The discharging reduces the possibility that observation and/or monitoring of the particles captured in the wells are adversely affected by the particles that re not captured.

Further, the fluid discharge channel unit may be used for collecting the particles captured in the wells. For example, first, the particles that are not captured in the wells are discharged to the outside of the chamber via the fluid discharge channel unit, as described above. Next, by applying pressure (e.g., positive pressure) opposite to the suction via the particle capturing channel unit, the particles are discharged from the wells, and the particles are discharged to the outside of the chamber via the fluid discharge channel unit. In this way, with the fluid discharge channel unit, it is also possible to collect the particles captured in the wells.

The particle capturing chamber according to the embodiment of the present disclosure may include not one fluid discharge channel unit but a plurality of (e.g., 2, 3, or 4) fluid discharge channel units. For example, the particle capturing chamber according to the embodiment of the present disclosure may include two fluid discharge channel units, one of them may be used for discharging the particles that are not captured in the wells, and the other may be used for collecting the particles captured in the wells.

### (4) Third Example of First Embodiment (Particle Capturing Chamber)

Another example of the particle capturing chamber according to the embodiment of the present disclosure will be described below with reference to FIG. 4. FIG. 4 is a schematic diagram showing an embodiment in which two particle capturing chambers according to the embodiment of the present disclosure are connected to each other.

In FIG. 4, two particle capturing chambers 400 and 450 are shown. The particle capturing chambers 400 and 450 are each the same as that described in FIG. 3. A fluid discharge channel unit 420 of the particle capturing chamber 400 is connected to a fluid supply channel unit 451 of a particle capturing chamber 450. A valve 452 is provided on the pipe connecting the fluid discharge channel unit 420 and the fluid supply channel unit 451.

In the embodiment shown in FIG. 4, particles that are not captured in the wells in the particle capturing chamber 400 can be supplied to the particle capturing chamber 450 via the fluid discharge channel unit 420 and the fluid supply channel unit 451, with the valve 452 opened. Then, in the particle capturing chamber 450, capturing of particles is performed again. In this embodiment, for example, the particles that are not captured in the wells by the suction force applied in the particle capturing chamber 400 can be captured in the particle capturing chamber 450 by a stronger suction force. As a result, for example, it is possible to classify particles by specific gravity, size, and the like of the particles.

### (5) Fourth Example of First Embodiment (Particle Capturing Chamber)

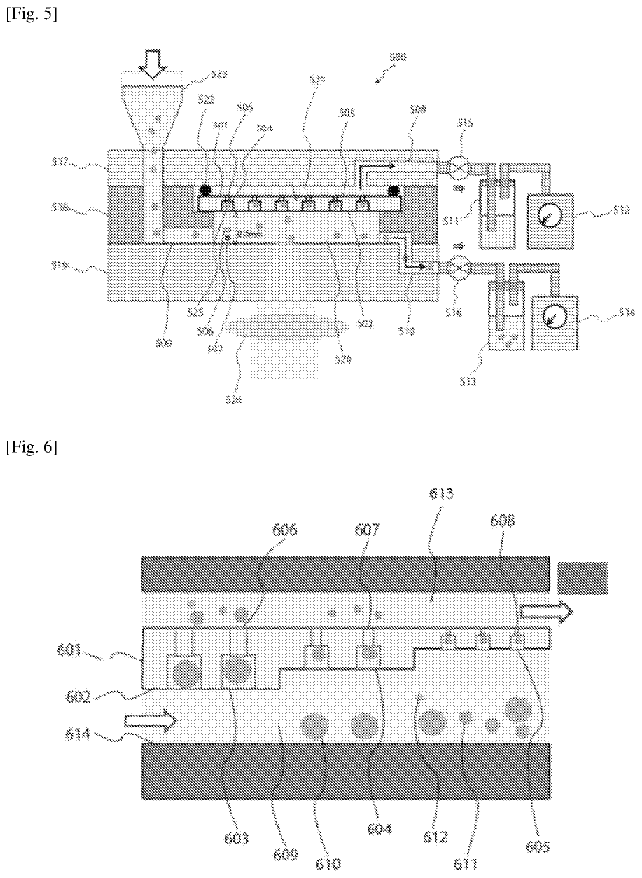

Another example of the particle capturing chamber according to the embodiment of the present disclosure will be described below with reference to FIG. 5. FIG. 5 is a schematic diagram showing capturing of particles by the particle capturing chamber according to the embodiment of the present disclosure and a state of observing the captured particles.

In FIG. 5, a particle capturing chamber 500 includes a particle capturing unit 501 therein. The particle capturing unit 501 has a particle capturing surface 502 facing the side on which the particle settles, and a surface 503 facing the side opposite thereto. The particle capturing surface 502 includes a plurality of wells 525. A hole 505 is provided at a bottom 504 of each of the wells. The hole 505 extends from the bottom 504 to the surface 503 facing the opposite side. The chamber 500 is disposed so that gravity acts on particles 506 in the direction indicated by an arrow 507. The wells 525 each have a dimension in which only one particle 506 is captured.

The particle capturing chamber 500 includes a particle capturing channel unit 508, a fluid supply channel unit 509, and a fluid discharge channel unit 510. A pump 512 is connected to the particle capturing channel unit 508 via a liquid collecting container 511. Similarly, a pump 514 is connected to the fluid discharge channel unit 510 via a liquid collecting container 513. A valve 515 is provided between the particle capturing channel unit 508 and the liquid collecting container 511. Further, a valve 516 is provided between the fluid discharge channel unit 510 and the liquid collecting container 513. These liquid collecting containers prevent, by suction using the pumps, liquid from entering the pumps.

In the particle capturing chamber 500, a first member 517, a second member 518, and a third member 519 constitute the space inside the chamber and the channel. In the first member 517, the second member 518, and the third member 519, a channel pattern is formed so as to form the space inside the chamber and the channel when the first member 517, the second member 518, and the third member 519 are stacked. Then, by stacking the members in which the channel pattern is formed, the space inside the chamber and the channel are formed. Specifically, the particle capturing chamber according to the embodiment of the present disclosure can be stacked materials including a plurality of layers. Forming the chamber with the stacked materials makes it possible to easily form the channel pattern.

In FIG. 5, the space inside the particle capturing chamber 500 is divided by the particle capturing unit 501 into a space 520 on the side on which the particle settles and a space 521 on the side opposite thereto. Further, in order to further ensure that these two spaces are communicated with each other via only the hole 505, a sealing member 522 such as an O-ring is sandwiched between the particle capturing unit 501 and the first member 517.

A container 523 capable of receiving fluid containing the particles is connected to the fluid supply channel unit 509. The fluid containing the particles is supplied from the container 523 to the space 520 on the side on which the particle settles via the fluid supply channel unit 509. The fluid supply channel unit 509 is provided so as to be communicate with the space 520 on the side on which the particle settles, on the side surface of the chamber. The fluid supply channel unit 509 is favorably provided to a part of the side surface of the chamber closest to the bottom of the chamber.

In the present disclosure, the length of the fluid supply channel unit, i.e., the length from the container 523 to the entrance of the chamber is favorably shorter in order to prevent particles from attaching or settling to/in the middle thereof. Further, for the fluid supply channel unit, a channel in which particles move from the lower side to the upper side and a channel having a bending part are not desirable. Therefore, for example, the fluid supply channel unit can favorably include only a channel in which particles move from the upper side to the lower side and/or a channel in which particles move in the horizontal direction. For example, as shown in FIG. 5, the fluid supply channel unit can include a channel in which particles move from the container 523 to the lower side and then move in the horizontal direction to enter the chamber. With such a channel, it is possible to prevent particles from attaching or settling to/in the channel. As a result, it is possible to perform suction with relatively low pressure while preventing particles from attaching or settling to/in the channel. With the relatively low pressure, it is possible to prevent particles from being damaged when the particles are captured, and prevent particles from passing through the holes. Suction by the pump 512 connected to the particle capturing channel unit 508 is performed via the particle capturing channel unit 508.

The fluid discharge channel unit 510 is provided so as to communicate with the space 520 on the side on which the particle settles, on the side surface of the chamber. The fluid discharge channel unit 510 is favorably provided to a part of the side surface of the chamber closest to the bottom of the chamber.

Since both of the fluid supply channel unit 509 and the fluid discharge channel unit 510 are provided to face each other on the side surface of the chamber, it is possible to more easily discharge the particles that have settled in the chamber.

Further, since at least one or favorably both of the fluid supply channel unit 509 and the fluid discharge channel unit 510 are provided to a part of the side surface of the chamber closest to the bottom of the chamber, it is possible to reduce the possibility that the flow formed to discharge the particles that have settled in the chamber affects the particles captured in the wells.

By performing suction using the pump 512, the fluid containing the particles is supplied from the container 523 to the space 520 on the side on which the particle settles via the fluid supply channel unit 509. By further continuing the suction, the particles 506 float in the space 520 on the side on which the particle settles, and each enter any of the wells 525. The particle 506 that has entered any of the wells 525 strikes the entrance of the hole 505, and stops moving. In this way, the particles are captured in the wells 525.

The particle capturing chamber 500 is configured so that the particles captured in the wells 525 can be observed by using inverted microscope 524. For example, the third member 519 is formed of a transparent material so that the particle capturing surface 502 can be observed, for example. As described above, by forming at least a part of the particle capturing chamber with a transparent material, it is possible to observe the captured particles by using, for example, a microscope. The inverted microscope 524 is disposed so that the wells 525 can be observed from below the chamber 500.

As described above, in the present disclosure, particles that are not captured in the wells are prevented from staying in the vicinity of the wells of the particle capturing unit. As a result, the distance between the particle captured in the well and the particle that is not captured in the well is large. Therefore, in the case of observing, by using the inverted microscope 524, the particles captured in the wells 525 described in FIG. 5, by focusing on the particles captured in the wells 525, the particles that are not captured in the wells fall outside the depth of field, i.e., cannot be observed. Therefore, it is possible to observe, by using the inverted microscope 524, the particles captured in the wells, without discharging the particles that are not captured in the wells from the chamber 500. It is of course possible to discharge the particles that are not captured in the wells to the outside of the chamber 500 via the fluid discharge channel unit 510.

Considering the result of the observation, it is possible to select a target particle. The selected particle can be obtained by using a single particle obtaining apparatus such as a micromanipulator.

Alternatively, the target particle may be automatically obtained using a single particle obtaining apparatus on the basis of image data or optical data (e.g., fluorescence data) obtained via the inverted microscope 524. For example, the single particle obtaining apparatus can execute a step of automatically obtaining all the particles that emit fluorescence above a predetermined fluorescence intensity.

### (6) Fifth Example of First Embodiment (Example of Particle Capturing unit)

Another example of the particle capturing chamber according to the embodiment of the present disclosure will be described below with reference to FIG. 6. FIG. 6 is a schematic diagram showing the inside of the particle capturing chamber according to the embodiment of the present disclosure.

In FIG. 6, a particle capturing unit 601 includes a particle capturing surface 602 having a staircase shape. The stages of the particle capturing surface 602 include wells 603, 604, and 605 having different sizes. The stages include holes 606, 607, and 608 having different sizes. A larger well is provided in the stage closer to a bottom surface 614 of the chamber, and a larger hole is provided in the larger well.

Particles 610, 611, and 612 having various sizes are supplied to a space 609 of the particle capturing chamber on the side on which the particle settles described in FIG. 6 via a fluid supply channel unit (not shown).

The largest particle 610 can be received by the largest well 603, but cannot be received by the smaller wells 604 and 605. Further, the largest particle 610 cannot pass through the hole 606 provided in the largest well 603, but the smaller particles 611 and 612 can pass through the hole 606. As a result, the largest particle 610 is captured in only the well 603 by suction on the side opposite to the side on which the particle settles.

Since the second largest particle 611 can be received by the largest well 603 but can pass through the largest hole 606, the particle 611 is not captured in the largest well 603 even by the above-mentioned suction. The particle 611 can be received by the smaller 604, and cannot pass through the hole 607 provided in the well 604. The particle 611 cannot be received by the smallest well 605. In this way, the particle 611 is captured in only the well 604 by the above-mentioned suction.

Since the smallest particle 612 can enter the largest well 603 and the second largest well 604 but can pass through the holes of these wells, the particle 621 is not captured in these wells even by the above-mentioned suction. The particle 612 can be received by the smallest well 605, and cannot pass through the hole 608 provided in the well 605. Therefore, the particle 612 is captured in only the well 605.

As shown in FIG. 6, in the wells 603, 604, and 605 having different sizes, particles having sizes corresponding to those of these wells are captured. Therefore, it is possible to classify and capture particles having various sizes depending on the size (e.g., particle size) of each particle.

Further, a larger well is provided at a stage closer to the bottom surface 614 of the chamber, on the particle capturing surface 602 shown in FIG. 6. In the case of performing suction for a predetermined time period, larger particles have a shorter distance to float, and smaller particles have a longer distance to float. Therefore, by providing a larger well at a stage closer to the bottom surface as described in FIG. 6, it is possible to capture particles having different sizes in wells having different sizes more efficiently, e.g., by performing suction a smaller number of times.

In the particle capturing chamber shown in FIG. 6, the second largest particle 611 and the smallest particle 612 can pass through the hole 606 or 607 by suction, and move to a space 613 on the side opposite to the space on the side on which the particle settles. The particles that have moved to the space 613 on the opposite side can be supplied to the space 609 on the side on which the particle settles via the fluid supply channel unit (not shown) again as necessary. Then, capturing of particles may be performed again. Alternatively, the particles that have moved to the space 613 on the opposite side may be simply collected or discarded.

As described above with reference to FIG. 6, in the particle capturing chamber according to the embodiment of the present disclosure, the particle capturing surface may have a staircase shape. In the particle capturing surface having a staircase shape, a larger well may be provided at a stage closer to the surface on which the particle settles. Further, a larger hole is provided in the larger well. With such a particle capturing surface, it is possible to efficiently classify particles depending on the sizes thereof.

### (7) Sixth Example of First Embodiment (Example of Particle Capturing Unit)

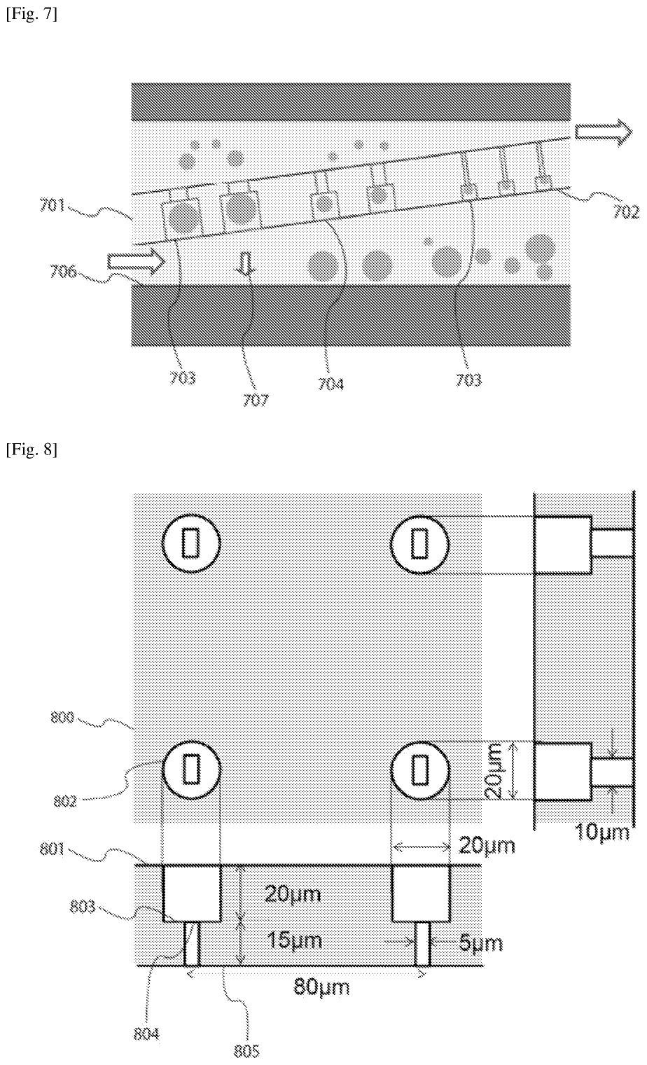

An example of the particle capturing chamber according to the embodiment of the present disclosure will be described below with reference to FIG. 7. FIG. 7 is a schematic diagram showing the inside of the particle capturing chamber according to the embodiment of the present disclosure.

In FIG. 7, a particle capturing unit 701 is provided so that a particle capturing surface 702 forms an angle of less than 90 degrees with respect to the direction (arrow 707) in which the particle settles, i.e., is inclined with respect to the bottom surface. The particle capturing surface 702 includes wells 703, 704, and 705 having different sizes. A larger well is provided at a stage closer to a bottom surface 706 of the chamber, and a larger hole is provided in the larger well.

By performing particle capturing by suction with the particle capturing unit 701 having the particle capturing surface 702, as described with reference to FIG. 6, particles having sizes corresponding to the sizes of the wells 703, 704, and 705 having different sizes are captured in the corresponding wells. Therefore, it is possible to classify and capture particles having various sizes depending on the size (e.g., particle size) of each particle.

As described above with reference to FIG. 7, in the particle capturing chamber according to the embodiment of the present disclosure, the particle capturing surface may be located to form an angle of less than 90 degrees with respect to the direction in which particles settle. The particle capturing surface closer to the surface on which particles settle may include a larger well. In addition, a larger hole is provided in a larger well. With such a particle capturing surface, it is possible to efficiently classify particles depending on the sizes of the particles.

### (8) Seventh Example of First Embodiment (Example of Well)

An example of wells provided in the particle capturing chamber according to the embodiment of the present disclosure will be described below with reference to FIG. 8. FIG. 8 is a schematic diagram showing an example of wells provided in the particle capturing chamber according to the embodiment of the present disclosure.

In FIG. 8, in a particle capturing surface 801 of a particle capturing unit 800, circular wells 802 are provided. The diameter and depth of each well 802 are respectively 20 μm and 20 μm. Further, a hole 804 is provided in a bottom surface 803 of each well. The entrance of the hole 804 has a slit shape, i.e., a rectangular shape with the long side of 10 μm and the short side of 5 μm. The hole 804 extends from the bottom surface 803 of the corresponding well to a surface 805 opposite to the particle capturing surface 801. Specifically, the hole 804 forms a space of a rectangular parallelepiped. The wells are arranged in the X direction and the Y direction at intervals of 80 μm.

The hole having a slit shape shown in FIG. 8 is particularly suitable in the case where particles have viscoelasticity, e.g., particles are cells. The length of the short side of the slit shape is favorably smaller than the dimension (e.g., diameter) of the particles, and can be, for example, not more than 2/3, more favorably, not more than 1/2 of the dimension of the particles. The length of the long side of the slit shape can be favorably not more than 1.2 times, more favorably not more than 1.1 times, even more favorably not more than the dimension (e.g., diameter) of the particles.

### (9) Eighth Example of First Embodiment (Particle Capturing Chamber)

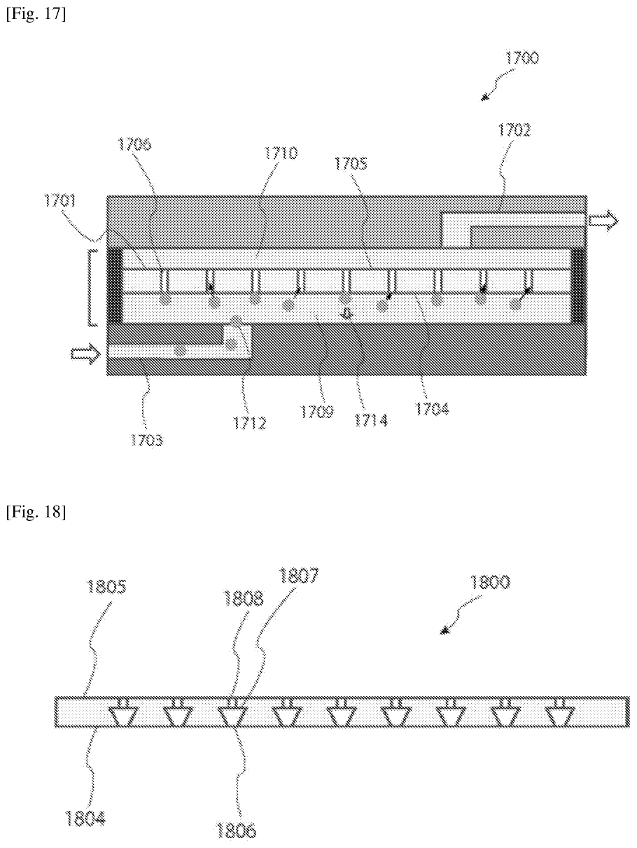

An example of the particle capturing chamber according to the embodiment of the present disclosure will be described below with reference to FIG. 17. FIG. 17 is a schematic diagram showing an example of a particle capturing chamber according to an embodiment of the present disclosure.

A particle capturing chamber 1700 shown in FIG. 17 is the same as the particle capturing chamber 100 shown in FIG. 1 except that the particle capturing unit includes through holes 1706 instead of the wells 106 of the particle capturing chamber 100. Specifically, in FIG. 17, the particle capturing chamber 1700 includes a particle capturing unit 1701, a particle capturing channel unit 1702, and a fluid supply channel unit 1703. The particle capturing unit 1701 has a particle capturing surface 1704 and a surface 1705 facing the side opposite thereto. The particle capturing surface 1704 includes the plurality of through holes 1706. The through holes 1706 each extend from the particle capturing surface 1704 to the surface 1705 opposite thereto. The shape of each of the through holes 1706 is a rectangular column shape. Specifically, the shape of the port of each through hole 1706 on the particle capturing surface 1704 is rectangle, and the rectangle is continued from the particle capturing surface 1704 to the surface 1705 opposite thereto. The particle capturing chamber 1700 is disposed so that gravity acts on particles 1712 in the direction indicated by an arrow 1714.

In FIG. 17, the space in the particle capturing chamber 1700 is divided by the particle capturing unit 1701 into a space 1709 on the side on which the particle settles and a space 1710 on the side opposite thereto.

To the fluid supply channel unit 1703, a container (not shown) storing fluid containing particles are connected. The fluid supply channel unit 1703 supplies the fluid containing the particles to the chamber 1700. The fluid supply channel unit 1703 is connected to the space 1709 on the side on which the particle settles, at the bottom (i.e., surface on which the particle settles) of the chamber 1700. The fluid containing the particles is supplied from the container to the space 1709 on the side on which the particle settles via the fluid supply channel unit 1703.

Note that the fluid supply channel unit 1703 may be connected to the space 1709 on the side on which the particle settles, at a part other than the bottom of the chamber. For example, the fluid supply channel unit 1703 may be provided so as to communicate with the space 1709 on the side on which the particle settles, on the side surface of the chamber.

The suction is performed, via the particle capturing channel unit 1702, by using a pump (not shown) connected to the particle capturing channel unit 1702. The particle capturing channel unit 1702 is connected to the space 1710 on the opposite side, at the top (i.e., surface opposite to the surface on which the particle settles) of the chamber 1700.

Note that the particle capturing channel unit 1702 may be provided at a part other than the top of the chamber. For example, the particle capturing channel unit 1702 may be provided so as to communicate with the space 1710 on the opposite side, on the side surface of the chamber.

By performing suction using the pump, the fluid containing the particles is supplied from the container to the space 1709 on the side on which the particle settles via the fluid supply channel unit 1703. By further continuing the suction, the particles 1712 float in the space 1709 on the side on which the particle settles, strikes the port of the through holes 1706, and stop moving. This is because the dimension of the port of each through hole 1706 is smaller than the dimension of each particle 1712, which prevents the particles 1712 from passing through the through holes 1706. In this way, the particles are captured in the through holes 1706.

With the particle capturing chamber 1700 shown in FIG. 17, the effect similar to that described in “(2) First Example of First Embodiment (Particle Capturing Chamber)” is exerted.

### (10) Ninth Example of First Embodiment (Example of Well)

Another example of wells provided in the particle capturing chamber according to the embodiment of the present disclosure will be described below with reference to FIG. 18. FIG. 18 is a schematic diagram showing an example of the particle capturing unit provided in the particle capturing chamber according to the embodiment of the present disclosure.

In FIG. 18, a particle capturing unit 1800 has a particle capturing surface 1804 and a surface 1805 facing the side opposite thereto. The particle capturing surface 1804 includes a plurality of wells 1806. A hole 1808 is provided at the bottom 1807 of each well. The hole 1808 extends from the bottom 1807 of each well to the surface 1805 opposite to the particle capturing surface.

Each of the wells 1806 has the smallest area at the entrance thereof, and the cross-sectional area of the well is gradually increased as it becomes closer to the hole 1808. Specifically, the well has a reverse taper, and the space inside the well is like a mortar. With such a shape, the particles that have entered the wells are prevented from getting out of the wells.

### (11) Tenth Example of First Embodiment (Example of Well)

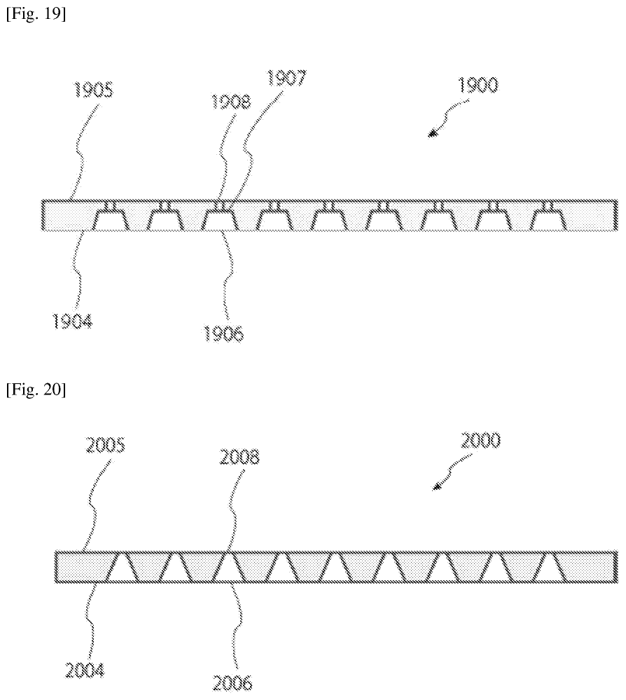

Another example of wells provided in the particle capturing chamber according to the embodiment of the present disclosure will be described below with reference to FIG. 19. FIG. 19 is a schematic diagram showing an example of the particle capturing unit provided in the particle capturing chamber according to the embodiment of the present disclosure.

In FIG. 19, a particle capturing unit 1900 has a particle capturing surface 1904 and a surface 1905 facing the side opposite thereto. The particle capturing surface 1904 includes a plurality of wells 1906. A hole 1908 is provided at the bottom 1907 of each well. The hole 1908 extends from the bottom 1907 of each well to the surface 1905 on the side opposite to the particle capturing surface.

The wells 1906 has the largest area at the entrance thereof, and the cross-sectional area of each well is gradually reduced as it becomes closer to the hole 1908. Specifically, the well has a taper, and the space inside the well is chevron. With such a shape, it is possible to more easily cause the particles to enter the wells.

### (12) Eleventh Example of First Embodiment (Example of Through Hole)

An example of a through hole provided in the particle capturing chamber according to the embodiment of the present disclosure will be described below with reference to FIG. 20. FIG. 20 is a schematic diagram showing an example of the particle capturing unit provided in the particle capturing chamber according to the embodiment of the present disclosure.

In FIG. 20, a particle capturing unit 2000 has a particle capturing surface 2004 and a surface 2005 facing the side opposite thereto. The particle capturing surface 2004 includes a plurality of through holes 2006. The through holes 2006 each have a chevron shape. Further, the side surface (i.e., inclined surface) of each through hole 2006 is linear. The shape of the port of the through holes 2006 on the particle capturing surface 2004 can be, for example, a circle, an ellipse, or a polygon (e.g., a rectangle), and the shape of a port 2008 on the surface 2005 on the opposite side can be, for example, a circle, an ellipse, or a polygon (e.g., a rectangle). The area of the former port is larger than the area of the latter port. Specifically, the cross-sectional area of each through hole 2006 is gradually reduced from the former port to the latter port. The latter port has a dimension that prevents a particle to be captured from passing through the latter port. Since the particle to be captured passes through the former port but does not pass through the latter port, the particle can be captured in the middle of the through holes 2006.

Since the through holes 2006 each have the above-mentioned shape, it is possible to more easily cause the particles to enter the through holes. Further, the through hole having such a shape can be produced more easily as compared with the well having a hole described above.

### (13) Twelfth Example of First Embodiment (Example of Through Hole)

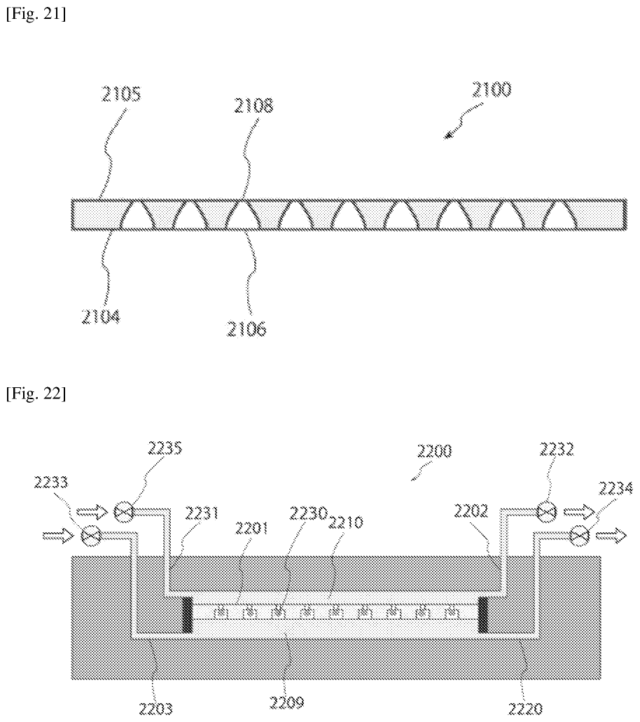

An example of the wells provided in the particle capturing chamber according to the embodiment of the present disclosure will be described below with reference to FIG. 21. FIG. 21 is a schematic diagram showing an example of the particle capturing unit provided in the particle capturing chamber according to the embodiment of the present disclosure.

In FIG. 21, a particle capturing unit 2100 has a particle capturing surface 2104 and a surface 2105 facing the side opposite thereto. The particle capturing surface 2104 includes a plurality of through holes 2106. The through holes 2106 each have a chevron shape. Further, the side surface (i.e., inclined surface) of each through hole 2106 is curved, i.e., draws an arc. The shape of the port of each through hole 2106 on the particle capturing surface 2104 can be, for example, a circle, an ellipse, or a polygon (e.g., a rectangle), and the shape of a port 2108 on the surface 2105 on the opposite side can be, for example, a circle, an ellipse, or a polygon (e.g., a rectangle). The area of the former port is larger than the area of the latter port. Specifically, the cross-sectional area of the through hole is gradually reduced from the former port to the latter port. The latter port has a dimension that prevents a particle to be captured from passing through the latter port. Since the particle to be captured passes through the former port but does not pass through the latter port, the particle can be captured in the middle of the through holes 2106.

Since the through holes 2106 each have the above-mentioned shape, it is possible to more easily cause the particles to enter the through holes. Further, the through hole having such a shape can be produced more easily as compared with the well having a hole described above.

### (14) Thirteenth Example of First Embodiment (Particle Capturing Chamber)

Another example of the particle capturing chamber according to the embodiment of the present disclosure will be described below with reference to FIG. 22. FIG. 22 is a schematic diagram showing an example of the particle capturing chamber according to the embodiment of the present disclosure.

A particle capturing chamber 2200 shown in FIG. 22 includes a particle capturing unit 2201, a particle capturing channel unit 2202, a first fluid supply channel unit 2203 connected to a space 2209 on the side on which the particle settles, a fluid discharge channel unit 2220, and a second fluid supply channel unit 2231 connected to a space 2210 on the side opposite to the side on which the particle settles. To the four channel units connected to the particle capturing chamber 2200, as shown in FIG. 22, a valve 2232, a valve 2233, a valve 2234, and a valve 2235 are connected.

Particle capturing using the particle capturing chamber 2200 shown in FIG. 22 may be performed by supplying fluid containing particles from the first fluid supply channel unit 2203 and performing suction via the particle capturing channel unit 2202 with the valves 2235 and 2234 closed.

As a result of the particle capturing, particles 2230 are captured in the wells. Particles that are not captured in the wells settle at the bottom of the space on the side on which the particle settles, by action of gravity.

After capturing the particles in the wells, the valve 2234 is opened. Then, the particles that have settled at the bottom are discharged to the outside of the particle capturing chamber 2200 via the fluid discharge channel unit 2220 by suction using a pump (not shown) connected to the tip of the valve 2234. The particles that have settled at the bottom may be discharged to the outside of the particle capturing chamber 2200 via the fluid discharge channel unit 2220 by liquid supply using a pump (not shown) connected to the first fluid supply channel unit 2203 in addition to or instead of the suction using the pump.

By bringing a predetermined reagent into contact with the particle 2230 captured in the well, it is possible to analyze the captured particle 2230. For example, in the case where the particle 2230 is a cell, the cell may be stimulated by using one or more reagents. With this configuration, it is possible to select a cell stimulated by the reagent. Alternatively, in the case where the particle 2230 is a cell, by binding a reagent (e.g., antibody) to the cell, a cell to which the reagent binds can be selected.

In order to bring the particle 2230 into contact with the reagent, after the particle 2230 is captured in the well, the fluid in the particle capturing chamber 2200 may be replaced with reagent-containing fluid. The replacement may be performed by, for example, supplying the reagent-containing fluid from the first fluid supply channel unit 2203 and the second fluid supply channel unit 2231 to the particle capturing chamber 2200 and performing suction via the particle capturing channel unit 2202 and the fluid discharge channel unit 2220.

As a result of the replacement, the reagent-containing fluid occupies the particle capturing chamber 2200. Further, the particle reacted with or bound to the reagent can be selectively obtained by using a single particle obtaining apparatus such as a micromanipulator.

Alternatively, the particles that are not reacted with or bound to the reagent may be selectively obtained and then the particles that have reacted with or bound to the reagent may be collectively collected by suction via the fluid discharge channel unit 2220. At the time of collective collection, for example, the particles can be taken out from the wells by supplying fluid from the second fluid supply channel unit 2231. At the time of collective collection, the valves 2232 and 2233 are favorably closed. With this configuration, it is possible to more efficiently perform collective collection.

As described above with reference to FIG. 22, since the particle capturing chamber according to the embodiment of the present disclosure includes the above-mentioned four channel units, it is possible to efficiently perform the fluid replacement in the chamber. As a result, the above-mentioned reaction or binding of the particles with/to the reagent and the particle collection thereafter can be performed.

In accordance with one of favorable embodiments of the present disclosure, the four channel units may be provided on the side surface of the particle capturing chamber 2200 as shown in FIG. 22. With this configuration, it is possible to more easily form flow in the particle capturing chamber 2200.

In accordance with one of favorable embodiments of the present disclosure, the connection part of the first fluid supply channel unit 2203 to the space 2209 on the side on which the particle settles can be located to face the connection part of the fluid discharge channel unit 2220 to the space 2209 on the side on which the particle settles. With this configuration, flow is easily formed at the time of the above-mentioned fluid replacement. As a result, it is possible to more efficiently perform the above-mentioned fluid replacement.

Similarly, in accordance with one of favorable embodiments of the present disclosure, the connection part of the second fluid supply channel unit 2231 to the space 2210 on the side opposite to the side on which the particle settles can be located to face the connection part of the particle capturing channel unit 2202 to the space 2210 on the side opposite to the side on which the particle settles. With this configuration, it is possible to more efficiently perform the above-mentioned fluid replacement.

### (15) Fourteenth Example of First Embodiment (Particle Capturing Chamber)

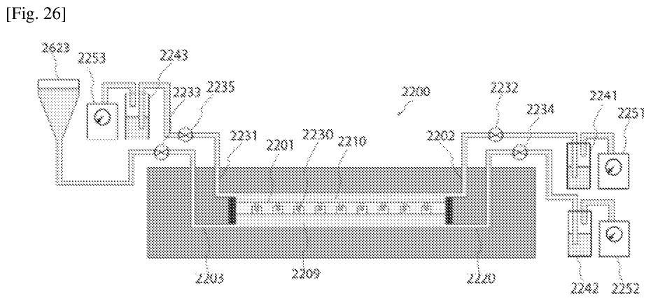

The state of particle capturing by the particle capturing chamber 2200, treatment of the captured particles with the reagent, and observation of the treated particles described in the above-mentioned “(14) Thirteenth Example of First Embodiment (Particle Capturing Chamber)” will be described below with reference to FIG. 26.

As shown in FIG. 26, to the particle capturing channel unit 2202, the fluid discharge channel unit 2220, and the second fluid supply channel unit 2231, respectively pumps 2251 to 2253 are connected via liquid collection containers 2241 to 2243. To the first fluid supply channel unit 2203, a container 2623 capable of storing the fluid containing particles is connected. On the first fluid supply channel unit 2203, the particle capturing channel unit 2202, the fluid discharge channel unit 2220, and the second fluid supply channel unit 2231, respectively, the valves 2232 to 2235 are provided. As the valve, it is favorable to use an electrically operated pinch valve. This is because the pinch valve is easy to externally control and is compact.

By performing suction using the pump via the particle capturing channel unit 2202 with the valves 2235 and 2234 closed, the fluid containing the particles are supplied from the container 2623 to the space 2209 on the side on which the particle settles, via the first fluid supply channel unit 2203. By further continuing the suction, the particles float in the space 2209 on the side on which the particle settles, and each enter any of the wells. The particle 2230 that has entered any of the wells strikes the entrance of the hole, and stops moving. In this way, the particles are captured in the wells.

The liquid in the container 2623 is replaced with reagent-containing liquid, and the reagent-containing liquid is supplied also to the container 2243 connected to the second fluid supply channel unit 2231. Then, suction by the pumps 2251 and 2252 connected to the particle capturing channel unit 2202 and the fluid discharge channel unit 2220 is performed with all the valves opened. In this way, the liquid in the chamber is replaced with the reagent-containing liquid. As a result, the reagent is brought into contact with the particles.

For example, in the case where the reagent is a fluorescently labelled antibody and the particles is a cell, the antibody binds to only the cell expressing, on the cell surface, the antigen to the antibody. As a result, the cell expressing the antigen is labeled with fluorescence.

After treatment with the reagent, for example, it is possible to observe the fluorescently labelled cell by using an inverted microscope. Alternatively, it is also possible to selectively obtain only the fluorescently labelled cell by using a single particle obtaining apparatus such as a micromanipulator.

### 2. Second Embodiment (Particle Capturing Chip)

### (1) Description of Second Embodiment

According to an embodiment of the present disclosure, there is provided a particle capturing chip including one of at least one well or at least one through hole, the particle capturing chip being used for capturing a particle in the well or with the through hole by sucking the particle to a side opposite to a side on which the particle settles, in a particle capturing chamber.

The particle capturing chip according to the embodiment of the present disclosure includes one of at least one well or at least one through hole. The particle is captured in the well or with the through hole. The particle capturing is performed by sucking the particle to the side opposite to the side on which the particle settles.

The particle capturing chip according to the embodiment of the present disclosure is used for capturing the particle in the well or with the through hole by sucking the particle to the side opposite to the side on which the particle settles. The particle capturing chip according to the embodiment of the present disclosure is used in the case of capturing the particle by such suction, and thus, the effect described in “1. First Embodiment (Particle Capturing Chamber)” can be exerted.

The particle capturing chip according to the embodiment of the present disclosure can be used in a particle capturing chamber. The particle capturing chamber can be, for example, the particle capturing chamber according to the embodiment of the present disclosure described in “1. First Embodiment (Particle Capturing Chamber)”. The particle capturing chip according to the embodiment of the present disclosure may constitute a part of the particle capturing unit of the particle capturing chamber according to the embodiment of the present disclosure, or may be the particle capturing unit.

A hole may be provided in the well of the particle capturing chip according to the embodiment of the present disclosure. The hole penetrates the particle capturing chip from the well to one surface of the particle capturing chip. The one surface can be, for example, a surface opposite to the surface on which the well is provided. By performing suction via the hole, the particle can be captured in the well. Further, by performing suction via the through hole in the particle capturing chip according to the embodiment of the present disclosure, the particle is captured with the through hole so as to block at least a part of the opening of the through hole.

All the matters described with respect to the particle capturing unit in “1. First Embodiment (Particle Capturing Chamber)” apply to the particle capturing chip according to the embodiment of the present disclosure. For example, all the matters described with respect to the well constituting the particle capturing unit, the hole provided in the well, the surface including the wells, the surface opposite thereto, and the through hole constituting the particle capturing unit in “1. First Embodiment (Particle Capturing Chamber)” apply to the particle capturing chip according to the embodiment of the present disclosure. For example, the particle capturing chip according to the embodiment of the present disclosure can include, in addition to the at least one well, a hole provided in the well, and have a surface including wells, and a surface opposite thereto.

### (2) Example of Second Embodiment (Particle Capturing Chip)

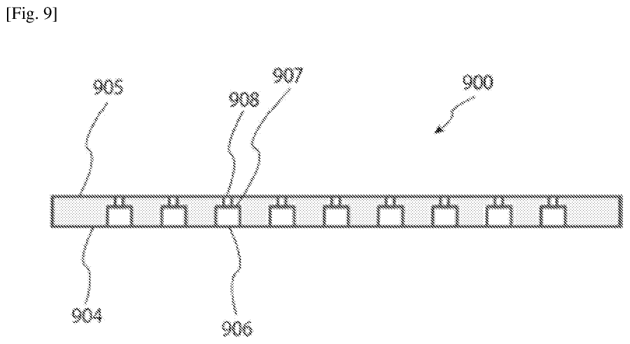

Hereinafter, the particle capturing chip according to the embodiment of the present disclosure will be described with reference to FIG. 9. FIG. 9 is a schematic diagram showing the particle capturing chip according to the embodiment of the present disclosure.

In FIG. 9, a particle capturing chip 900 has a particle capturing surface 904 and a surface 905 facing the side opposite thereto. The particle capturing surface 904 includes a plurality of wells 906. A hole 908 is provided at the bottom 907 of each well. The hole 908 extends from the bottom 907 of each well to the surface 905 opposite to the particle capturing surface. In particle capturing, the particle capturing chip 900 is disposed so that the port of the well 906 faces the action direction of gravity on the particles, and used. The wells 906 each have, for example, a dimension in which only one particle enters.

### (3) Another Example of Second Embodiment (Example of Chip and Chip holder)

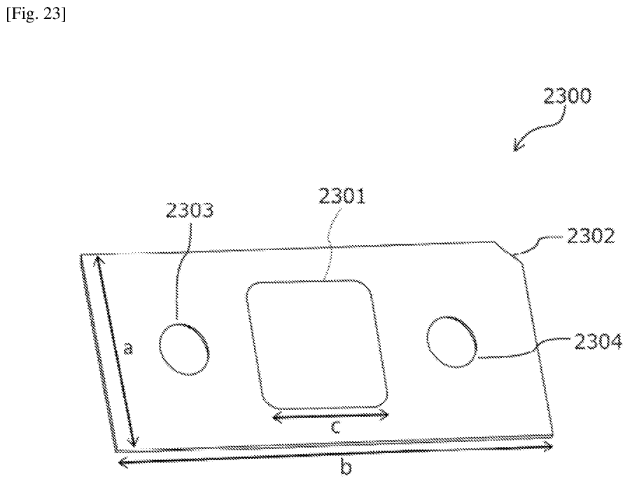

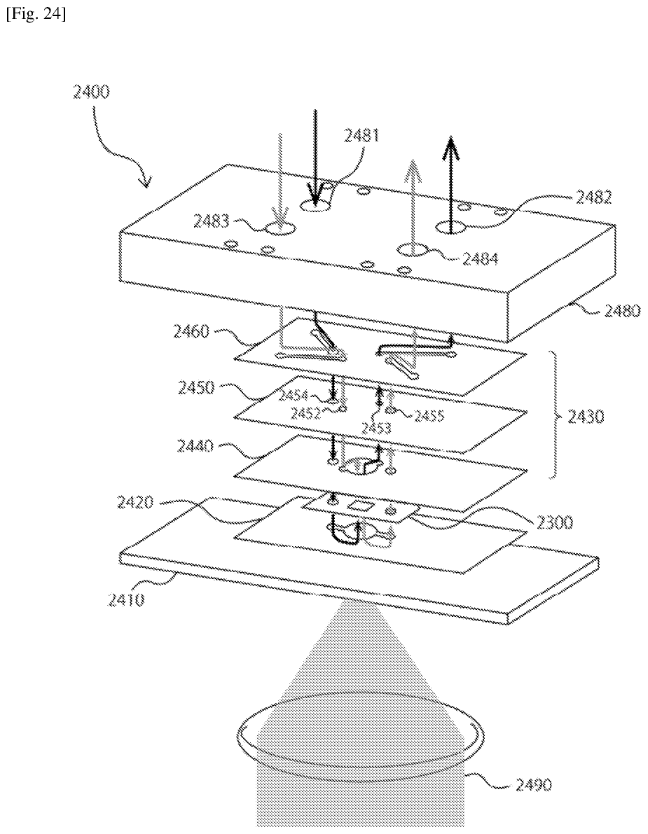

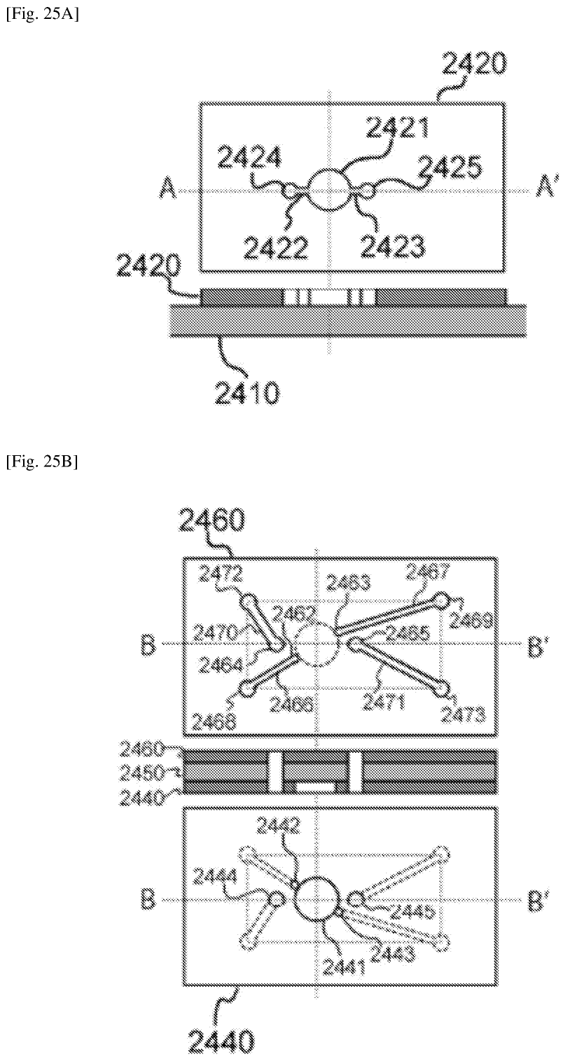

In accordance with one favorable embodiment of the present disclosure, the particle capturing chamber according to the embodiment of the present disclosure can include, for example, a particle capturing chip and a chip holder holding the chip. An example of a particle capturing chip and a chip holder forming the particle capturing chamber 2200 described in 1. “(14) Thirteenth Example of First Embodiment (Particle Capturing Chamber)” will be described below with reference to FIGS. 23 to 25. FIG. 23 is a diagram showing an example of a particle capturing chip having a particle capturing area. FIG. 24 is a diagram showing an example of a method of stacking a plurality of parts forming a chip holder for holding the particle capturing chip. FIG. 25 is a diagram showing an example of the plurality of parts.

(3-1) Chip

A chip 2300 shown in FIG. 23 is a rectangular parallelepiped (i.e., thin plate-like shape) with a short side a of 8 mm, a long side b of 18 mm, and a thickness of 0.15 mm. The chip 2300 has a particle capturing area 2301 of a square with one side of 5 mm at the center thereof.

In accordance with the present disclosure, the shape of the chip is not limited to the rectangular plate-like shape shown in FIG. 23. For example, the shape of the chip can have a square, circular, or elliptical plate-like shape. The size of the chip may be appropriately selected by those skilled in the art. In the case where the chip is a rectangle, the length of one side of the rectangle is favorably 3 mm to 50 mm, more favorably 5 mm to 30 mm. In the case where the chip is a circle or an ellipse, the diameter or major diameter thereof is favorably 3 mm to 50 mm, more favorably 5 mm to 30 mm. In accordance with the present disclosure, the shape of the particle capturing area is not limited to a square. The shape of the particle capturing area may be, for example, a rectangle, a circle, or an ellipse.

In the case where the particle capturing area is a rectangle, the length of one side of the rectangle can be favorably 1 mm to 20 mm, more favorably 2 to 10 mm. In the case where the particle capturing area is a circle or an ellipse, the diameter or major diameter thereof can be favorably 1 mm to 20 mm, more favorably 2 to 10 mm.

In the particle capturing area 2301 of the chip 2300, 63×63=approximately 4000 wells are provided. The wells are provided, for example, in the X direction and the Y direction at intervals of 80 μm.

The thickness of the particle capturing area 2301 of the chip 2300 shown in FIG. 23 is approximately 0.15 mm.

As shown in FIG. 23, the particle capturing area 2301 is surrounded by a surrounding area 2302. The surrounding area 2302 includes through holes 2303 and 2304. The through holes 2303 and 2304 are provided on both sides of the particle capturing area 2301. The through holes 2303 and 2304 are used for injecting fluid into the chamber or discharging the fluid from the chamber, as will be described later.

The chip 2300 is mounted so as to form a space on the side on which the particle settles and a space on the side opposite thereto in the chip holder.

(3-2) Chip Holder

The chip holder can form the space on the side on which the particle settles and the space on the side opposite thereto in particle capturing chamber, together with the particle capturing chip. Further, the chip holder can include the particle capturing channel unit, and another channel unit arbitrarily. The chip holder can be produced by stacking a plurality of parts designed to form the two spaces and these channel units when stacked. An example of the chip holder will be described with reference to FIGS. 24 and 25.

A chip holder 2400 shown in FIG. 24 is formed by stacking a plurality of parts. The chip holder 2400 is formed by stacking a cover glass 2410, a one-layer channel sheet 2420 formed of PDMS, a sealing film (not show) housing the chip 2300, a three-layer channel sheet 2430 formed of PDMS, and an acrylic cover plate 2480 in order from the bottom. These parts may be screwed, for example, so that no gap is generated between the parts. Further, since the chip 2300 is sandwiched between the two flexible sheets formed of PDMS, the sealing property is secured.

Hereinafter, these parts will be described in detail.

The cover glass 2410 can be attached to the one-layer channel sheet 2420 to be integrated. The attachment may be performed by, for example, a surface activation treatment using plasma. Since the cover glass 2410 and the one-layer channel sheet 2420 are transparent, it is possible to observe the particle capturing surface of the chip 2300 by using a microscope 2490.

FIG. 25A is a schematic diagram showing the one-layer channel sheet 2420. As shown in the schematic diagram, a hole 2421 is opened at the center of the one-layer channel sheet 2420. For that reason, by stacking the cover glass 2410 and the one-layer channel sheet 2420, the hole 2421 forms a space on the side on which the particle settles in the particle capturing chamber. At the lower portion of FIG. 25A, a cross-sectional view taken along the line A-A′ in the state where the one-layer channel sheet 2420 and the cover glass 2410 are stacked is shown. As shown in the cross-sectional view, the part of the cover glass 2410 corresponding to the position of the hole 2421 forms the bottom of the particle capturing chamber.

The hole 2421 may have a size that covers the particle capturing area. The hole 2421 has a circular shape with, for example, the diameter of 6 mm to cover the particle capturing area 2301 of a 5 mm square.

On both sides of the hole 2421, two linear channels 2422 and 2423 are provided. The width of the channels 2422 and 2423 is 1 mm. The channel 2422 is connected to a hole 2424 with a diameter of 2 mm, for example. Further, the channel 2423 is connected to a hole 2425 with a diameter of 2 mm.

By sandwiching the one-layer channel sheet 2420 by the cover glass 2410 and the chip 2300, the cover glass 2410 becomes the bottom of the channels 2422 and 2423, and the chip 2300 becomes the upper surface of the channels 2422 and 2423. The channel 2422 and the hole 2424 forms a liquid supplying channel unit for supplying particle-containing fluid to the chamber according to the embodiment of the present disclosure. The channel 2423 and the hole 2425 form a fluid discharge channel unit according to the embodiment of the present disclosure.

The sealing film is a sealing part covering the surroundings of the chip 2300 when sandwiching the chip 2300 by the one-layer channel sheet 2420 and the three-layer channel sheet 2430 formed of PDMS. The thickness of the sealing film may be the same or substantially the same as the thickness of the chip 2300. The thickness of the sealing film is, for example, the same as the thickness of the chip shown in FIG. 23, i.e., 0.15 mm.

The sealing film may be hollowed out at the center thereof so that the chip 2300 can be received in the central part. For example, the central part may be hollowed out to have a shape slightly larger than the shape of the chip 2300 of 18 mm×8 mm.

The three-layer channel sheet 2430 includes three PDMS layers stamped to have different patterns. The three layers are a chamber forming layer 2440, a matrix layer 2450, and a channel forming layer 2460 in order from the side on which the particle settles. The thicknesses of the chamber forming layer 2440, the matrix layer 2450, and the channel forming layer 2460 are, respectively, 1 mm, 2 mm, and 1 mm, for example.

A schematic diagram of the chamber forming layer 2440 is shown in the lower part of FIG. 25B. The schematic diagram is a schematic diagram when the chamber forming layer 2440 is viewed from the side of the inverted microscope 2490. As shown in the schematic diagram, the chamber forming layer 2440 includes a hole 2441. The hole 2441 has, for example, a circular shape with a diameter of 6 mm similarly to the hole 2421. By stacking the chamber forming layer 2440 and the matrix layer 2450, the hole 2441 forms a space on the side opposite to the side on which the particle settles in the particle capturing chamber, and the matrix layer 2450 becomes the top surface of the space. At the center of FIG. 25B, a cross-sectional view taken along the line B-B′ is shown. As shown in the cross-sectional view, the matrix layer 2450 forms the top surface of the space.

In the chamber forming layer 2440, two small holes 2442 and 2443 are formed to face each other. The small holes 2442 and 2443 are connected to the hole 2441. The diameter of each of the small holes 2442 and 2443 is, for example, 1 mm.

In addition, in the chamber forming layer 2440, other two holes 2444 and 2445 are formed to face each other with the hole 2441 disposed therebetween. The holes 2444 and 2445 are not connected to the hole 2441, i.e., are provided at a predetermined interval from the hole 2441. The diameter of each of the holes 2444 and 2445 is, for example, 2 mm.

In the matrix layer 2450, as shown in FIG. 24, two small holes 2452 and 2453 are formed. The diameter each of the holes is, for example, 1 mm.

Further, in the matrix layer 2450, two holes 2454 and 2455 are formed. The diameter of each of the holes is, for example, 2 mm.

A schematic diagram of the channel forming layer 2460 is shown in the upper part of FIG. 25B. The schematic diagram is a schematic diagram when the channel forming layer 2460 is viewed from the cover plate 2480. As shown in the schematic diagram, in the channel forming layer 2460, two small holes 2462 and 2463 are formed. The small holes 2462 and 2463 are respectively connected to channels 2466 and 2467. The diameter of each of the small holes is, for example, 1 mm. The width of each of the channels is, for example, 1 mm. The channels 2466 and 2467 are respectively connected to holes 2468 and 2469 at the terminals thereof.

Further, in the channel forming layer 2460, two holes 2464 and 2465 are formed. The diameter of each of the holes is, for example, 2 mm. The holes 2464 and 2465 are respectively connected to channels 2470 and 2471. The width of each of the channels is, for example, 1 mm. The channels 2470 and 2471 are respectively connected to holes 2472 and 2473 at the terminals thereof. The diameter of each of the holes is, for example, 2 mm.

By sandwiching the channel forming layer 2460 by the matrix layer 2450 and the cover plate 2480, the matrix layer 2450 becomes the bottom surface of the four channels 2466, 2467, 2470, and 2471, and the cover plate 2480 becomes the top surface of the four channels.

The sizes of the holes, the widths of the channels, and the thicknesses of the layers described above may be appropriately changed depending on, for example, the particle size and the like.

In the cover plate 2480, four holes 2481, 2482, 2483, and 2484 are formed. The cover plate 2480 only needs to have a shape that forms the entire surface of the channel forming layer 2460 or forms at least the top of the channel of the channel forming layer. For example, the cover plate 2480 is an acrylic plate with an outer shape of 75 mm×35 mm×5 mm (thickness) in which circular holes with a diameter of 2 mm are provided as the above-mentioned four holes. To the four holes, piping tubes can be connected. Via the piping tubes, fluid is supplied or discharged. To the tubes, various containers and/or pumps can be connected via the valves 2232 to 2235.

Note that it is desirable that the connection parts between the piping tubes and the holes are reliably sealed. With this configuration, it is possible to prevent the air from being contained in the fluid at the time of supplying or discharging the fluid, and bubbles that interfere with the flow of the fluid from being generated. Further, the piping tube is favorably transparent or semitransparent. With this configuration, it is possible to visually observe bubbles in the piping.

The first fluid supply channel unit 2203 of the particle capturing chamber 2200 is formed by the hole 2481 of the cover plate 2480, the hole 2472, the channel 2470, and the hole 2464 of the channel forming layer 2460, the hole 2454 of the matrix layer 2450, the hole 2444 of the chamber forming layer 2440, the through hole 2303 of the chip 2300, and the hole 2424 and the channel 2422 of the one-layer channel sheet 2420.

The particle-containing fluid passes through the components in the stated order, and is introduced into the space on the side on which the particle settles in the chamber.

The particle capturing channel unit 2202 of the particle capturing chamber 2200 is formed by the small hole 2443 of the chamber forming layer 2440, the small hole 2453 of the matrix layer 2450, the small hole 2463, the channel 2467, and the hole 2469 of the channel forming layer 2460, and the hole 2482 of the cover plate 2480.

At the time of suction for particle capturing, the fluid passes through the components in the stated order.

The direction of flow in the case of introducing, via the first fluid supply channel unit 2203, the particle-containing fluid into the space on the side on which the particle settles in the chamber and performing suction via the particle capturing channel unit 2202 for particle capturing is indicated by a black arrow line in FIG. 24.

The second fluid supply channel unit 2231 of the particle capturing chamber 2200 is formed by the hole 2483 of the cover plate 2480, the hole 2468, the channel 2466, and the small hole 2462 of the channel forming layer 2460, the small hole 2452 of the matrix layer 2450, and the small hole 2442 of the chamber forming layer 2440. At the time of introducing the fluid into the space on the side opposite to the space on the side on which the particle settles in the chamber, the fluid passes through the components in the stated order.

The fluid discharge channel unit 2220 of the particle capturing chamber 2200 is formed by the channel 2423 and the hole 2425 of the one-layer channel sheet 2420, the through hole 2304 of the chip 2300, the hole 2445 of the chamber forming layer 2440, the hole 2455 of the matrix layer 2450, the hole 2465, the channel 2471, and the hole 2473 of the channel forming layer 2460, and the hole 2484 of the cover plate 2480. At the time of discharging the fluid from the space on the side on which the particle settles in the chamber, the fluid passes through the components in the stated order. The direction of the flow in the case of introducing, via the second fluid supply channel unit 2231, the fluid into the space on the side opposite to the side on which the particle settles in order to discharge the particles from the wells and discharging the particles that have gotten out of the wells from the chamber via the fluid discharge channel unit 2220 is indicated by a gray arrow line in FIG. 24.

The material defining the space in the particle capturing chamber according to the embodiment of the present disclosure is favorably rubber resin such as PDMS described in this example. With this configuration, it is possible to hermetically seal the particle capturing chip so that no liquid leaks.

Further, the particle capturing chamber according to the embodiment of the present disclosure favorably includes, for example, a first fluid supply channel unit, a particle capturing channel unit, a second fluid supply channel unit, and a fluid discharge channel unit as described in this example, and the four channel units communicate with the four holes, i.e., inlets or outlets of the cover plate 2480. Specifically, the particle capturing chamber shown in this example includes two inlets and two outlets, and further includes a channel in the chip holder communicating with these inlets and outlets. The number of inlets and outlets may be increased as necessary, and a channel in the chip holder may be appropriately added.

Further, in accordance with the present disclosure, the inlets and the outlets can be favorably provided in one surface (upper surface of the lid part in this example). With this configuration, it is possible to more easily mount or replace the particle capturing chamber on the particle analysis system to be described below.

Further, in accordance with the present disclosure, a channel through which fluid flows upward or downward can be favorably provided in the chip holder. For example, as shown in this example, the channel can be formed by holes. With such a bypass structure, it is possible to cause the fluid to flow upward or downward and provide the inlets and outlets in one surface.

### 3. Third Embodiment (Particle Capturing Method)

### (1) Description of Third Embodiment

According to an embodiment of the present disclosure, there is provided a particle capturing method including: capturing a particle in a well or with a through hole by sucking the particle to a side opposite to a side on which the particle settles. In the particle capturing step, a particle is sucked to the side opposite to the side on which the particle settles. By the suction, the particle moves to the chamber, and is captured in the well or with the through hole.

In the method according to the embodiment of the present disclosure, by sucking the particle to the side opposite to the side on which the particle settles, the particle is captured in the well or with the through hole. As described above, since the particle is captured in the well or with the through hole, the effect described in “1. First Embodiment (Particle Capturing Chamber)” can be exerted.

The particle capturing method according to the embodiment of the present disclosure can be performed in a particle capturing chamber. The particle capturing chamber can be, for example, the particle capturing chamber according to the embodiment of the present disclosure described in “1. First Embodiment (Particle Capturing Chamber)”. By performing the method according to the embodiment of the present disclosure in the particle capturing chamber according to the embodiment of the present disclosure, it is possible to more efficiently capture particles.

### (2) First Example of Third Embodiment (Particle Capturing Method)

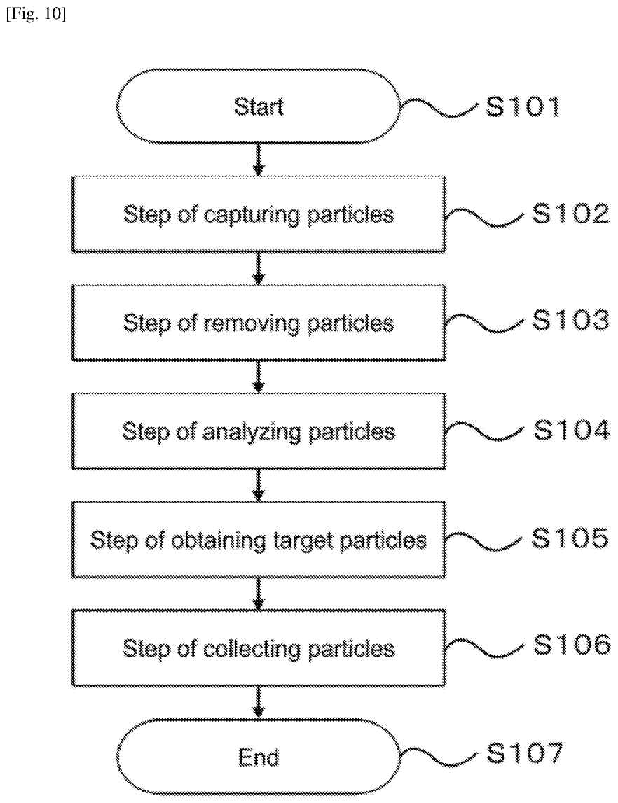

Hereinafter, the particle capturing method according to the embodiment of the present disclosure will be described with reference to FIG. 5 and FIG. 10. FIG. 10 is a flowchart showing the particle capturing method according to the embodiment of the present disclosure performed in the particle capturing chamber 500 shown in FIG. 5. As shown in the flowchart of FIG. 10, a step of capturing particles, a step of removing uncaptured particles, a step of analyzing captured particles, a step of obtaining desired particles from the captured particles, and a step of collecting other captured particles are performed.

In Step S101, the particle capturing method according to the embodiment of the present disclosure is started. Prior to the start of the particle capturing method, fluid containing particles is supplied to the container 523.

In Step S102, the particle capturing step is performed. Prior to suction of particles, the valve 516 provided between the fluid discharge channel unit 510 and the liquid collecting container 513 may be closed. In the particle capturing step, when the valve 515 is opened and suction by the pump 512 is started, by the suction, the liquid containing particles passes through the fluid supply channel unit 509 from the container 523 to enter the space 520 on the side on which the particle settles of the particle capturing chamber 500. By further continuing the suction, the particles 506 float in the space 520 on the side on which the particle settles to enter the wells 525. The particles 506 that have entered the wells 525 each strike the entrance of the hole 505 and stop moving. In this way, the particles are captured in the wells 525. In the particle capturing step, the suction is stopped or the suction force is reduced after a predetermined time period has elapsed from the start of the suction. As a result, the floating of the particles in the chamber is stopped, and the particles that are not captured in the wells settle on the bottom surface of the chamber.

In Step S103, the step of removing particles that are not captured in the wells is performed. In the removing step, the particles that are not captured in the wells can be discharged from the particle capturing chamber 500. For example, in the removing step, first, the valve 515 is closed and the valve 516 is opened. Next, in order to discharge the particles that are not captured in the wells from the chamber 500, suction is performed using the pump 514. By the suction, the particles that have settled on the bottom surface of the chamber are discharged from the chamber 500 via the fluid discharge channel unit 510, and collected in the container 513. In the removing step, particles that do not float, by a suction force applied in Step S102, in the space 520 on the side on which the particle settles are also removed.

There is a distance, which corresponds to at least the height of the space 520 on the side on which the particle settles between the particle captured in the well and the particle that has settled in the space 520 on the side on which the particle settles. Because of this distance, even in the case where suction is performed to form flow with a relatively high flow velocity, the possibility that the particle captured in the well gets out of the well and/or the particle captured in the well is damaged is low. The removing step may be performed while holding the particles in the wells by suction using the pump 512 with the valve 515 opened.

In Step S104, the step of analyzing the particles captured in the wells is performed. In the analyzing step, for example, observation using the inverted microscope 524 can be performed. Further, in the analyzing step, analysis using an analysis apparatus other than the inverted microscope may be performed. In the analyzing step, for example, fluorescence emitted by each particle can be analyzed using a photodetector.

In order to reduce damage to the particles, the analysis can be performed in the state where a suction force smaller than that applied in the particle capturing step is applied or no suction is performed. In order to further reduce damage to the particles, favorably, the analysis can be performed in the state where no suction is performed. In the particle capturing chamber according to the embodiment of the present disclosure, even in the state where no suction is performed, the particles, particularly cells can be captured in the wells. Further, since the damage to the particle is further reduced with such analysis, it is also possible to observe the particles for a longer time.

In Step S105, the step of obtaining desired particles from the captured particles is performed. In the obtaining step, first, as a result of the analysis in Step S104, desired particles are selected. For example, particles with desired forms or particles emitting desired fluorescence can be selected. Then, the selected particles can be obtained using a single article obtaining apparatus such as a micromanipulator.

In Step S106, the step of collecting other captured particles, i.e., particles that are not selected in Step S105 is performed. First, the valve 515 is opened and the valve 516 is closed. Next, pressure (e.g., positive pressure) is applied by the pump 512 so that particles get out of the well. The particles that have gotten out of the wells pass through the fluid supply channel unit 509 and are collected in the container 523.

In Step S107, the particle capturing method according to the embodiment of the present disclosure is finished.

In the above-mentioned flow, it is possible to observe the particles one by one. Further, it is also possible to obtain only one target particle. Further, other particles captured in the wells and particles that are not captured in the wells can be collected, and these particles can be used for another experiment.

Further, in the above-mentioned flow, a particle capturing chamber including through holes instead of the wells may be used.

### (3) Second Example of Third Embodiment (Another Example of Particle Collecting Step)

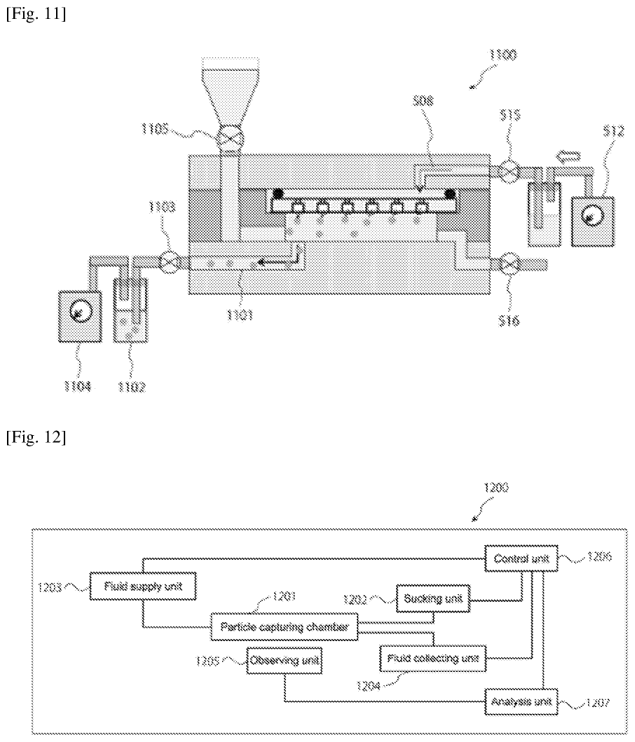

Another embodiment of Step S106 (Particle Collecting Step) in the flow described in (2) with reference to FIG. 10 will be described below with reference to FIG. 11. FIG. 11 is a diagram showing another example of the particle capturing chamber according to the embodiment of the present disclosure.

A particle capturing chamber 1100 shown in FIG. 11 is the same as the particle capturing chamber shown in FIG. 5 except that a fluid discharge channel unit 1101, a liquid colleting container 1102, a valve 1103 provided between the liquid colleting container 1102 and the fluid discharge channel unit 1101, a pump 1104 connected to the fluid discharge channel unit 1101 via the liquid colleting container 1102 are added, and a valve 1105 is provided between the fluid supply channel unit 509 and the container 523.

In the case of using the particle capturing chamber 1100 shown in FIG. 11, Step S106 can be performed, for example, as follows. Specifically, first, the valve 1105 and the valve 516 are closed, and the valve 515 and the valve 1103 are opened. Pressure (e.g., positive pressure) is applied by the pump 512 connected to the particle capturing channel unit 508 so that particles get out of the wells. The particles that have gotten out of the wells pass through the fluid discharge channel unit 1101 and are collected in the container 1102. Further, as necessary, in order to prompt particles to enter the fluid discharge channel unit 1101, suction using the pump 1104 may be performed.

In the particle collecting step of the particle capturing method using the particle capturing chamber shown in FIG. 5, there is a possibility that particles that can remain in the fluid supply channel and particles captured in the wells mix with each other. Meanwhile, by performing the particle collecting step as described above using the particle capturing chamber shown in FIG. 11, the possibility is eliminated.

### (4) Third Example of Third Embodiment (Particle Capturing Method)

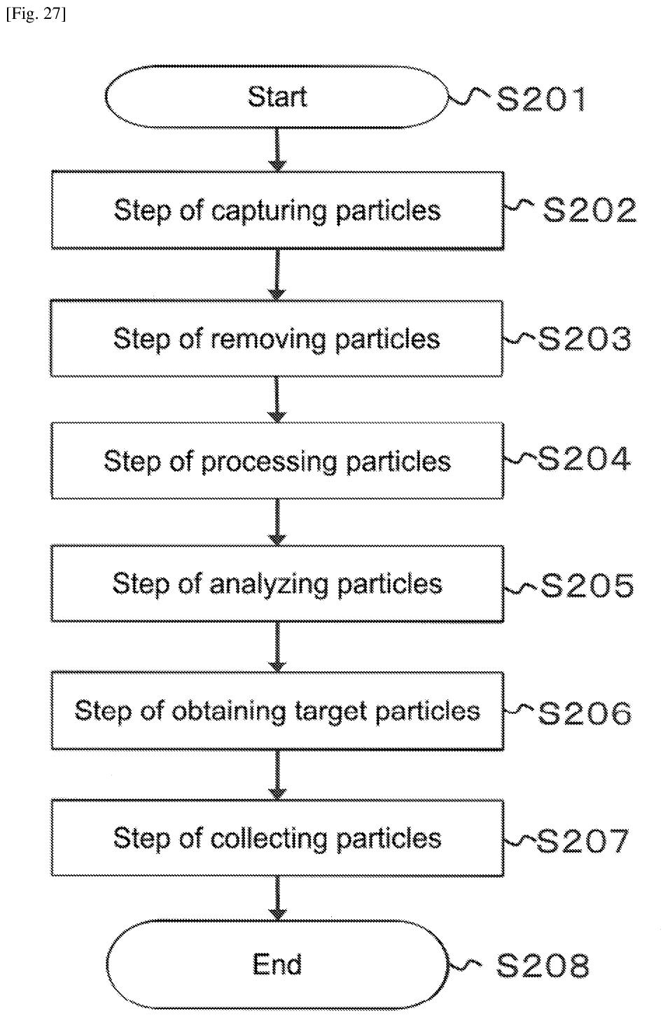

Hereinafter, the particle capturing method according to the embodiment of the present disclosure will be described with reference to FIG. 26 and FIG. 27. FIG. 26 is as described above. FIG. 27 is a flowchart showing an example of the particle capturing method according to the embodiment of the present disclosure performed in the particle capturing chamber shown in FIG. 26. In the flow shown in FIG. 10, a step of capturing particles, a step of removing particles that are not captured, a step of processing the captured particles, a step of analyzing the captured particles, a step of obtaining desired particles from the captured particles, and a step of collecting other captured particles are performed.

In Steps S201, S202, and S203, procedures similar to Steps S101, S102, and S103 described in “(2) First Example of Third Embodiment (Particle Capturing Method)” may be performed. Note that these steps may be performed with the valve 2235 on the second fluid supply channel unit 2231 closed. Further, before starting these steps, in order to fill the chamber with fluid, the fluid may be introduced from the second fluid supply channel unit 2231 into the chamber with the valve 2235 opened.

In Step S204, the particles captured in the wells are processed. In Step S204, first, the fluid in the container 2623 connected to the first fluid supply channel unit 2203 and the fluid in the container 2243 connected to the second fluid supply channel unit 2231 are replaced with fluid for the processing. Alternatively, both of the containers 2623 and 2243 may be replaced with other containers containing the fluid for the processing.

Next, all the valves 2232 to 2235 on the first fluid supply channel unit 2203, the particle capturing channel unit 2202, the fluid discharge channel unit 2220, and the second fluid supply channel unit 2231 are opened. Then, by performing suction using the pumps connected to the particle capturing channel unit 2202 and the fluid discharge channel unit 2220, the fluid in the chamber is replaced.

Alternatively, replacement of the fluid in the space 2209 on the side on which the particle settles may be performed first, and then replacement of the fluid in the space 2210 on the side opposite to the side on which the particle settles may be performed. Alternatively, replacement of the fluid in/the space 2210 on the side opposite to the side on which the particle settles may be performed first, and then replacement of the fluid in the space 2209 on the side on which the particle settles may be performed. For the replacement of the fluid in the space 2209 on the side on which the particle settles, suction using the pump 2252 connected to the fluid discharge channel unit 2220 can be performed with the valve 2233 on the first fluid supply channel unit 2203 and the valve 2234 on the fluid discharge channel unit 2220 opened. For the replacement of the fluid in the space 2210 on the side opposite to the side on which the particle settles, suction using the pump 2251 connected to the particle capturing channel unit 2202 can be performed with the valve 2235 on the second fluid supply channel unit 2231 and the valve 2232 on the particle capturing channel unit 2202 opened.

As described above, the particle capturing method according to the embodiment of the present disclosure can include the step of replacing the fluid in the particle capturing chamber.

In Steps S205 and S206, procedures similar to Steps S104 and S105 described in “(2) First Example of Third Embodiment (Particle Capturing Method)” may be performed.

Further, the particle analyzing step in Step S205 may be further performed between Step S203 and Step S204. As a result, it is possible to compare the changes before and after the particle processing in Step S204.

Further, Step S206 may be omitted. Further, all the particles processed in Steps S204 may be collectively collected in Step S207.

In Step S207, a step of collecting other captured particles, i.e., particles that are not selected in Step S206 is performed. The collecting step may be performed, for example, by introducing fluid from the second fluid supply channel unit 2231 and performing suction using the pump 2252 connected to the fluid discharge channel unit 2220 with the valve 2232 on the particle capturing channel unit 2202 and the valve 2233 on the first fluid supply channel unit 2203 closed and the valve 2234 on the fluid discharge channel unit 2220 and the valve 2235 on the second fluid supply channel unit 2231 opened. In this way, particles are collected in the container 2242.

In Step S208, the particle capturing method according to the embodiment of the present disclosure is finished.

### (5) Fourth Example of Third Embodiment (Example of Operation for Capturing Particles)

A specific example of the operation for capturing particles using the particle capturing chamber shown in FIG. 26, processing the captured particles, and then collecting the processed particles will be described below with reference to Tables 1 to 3.

In the operation example described in the following Tables 1 to 3, particles to be captured are cells, and the cells are to be processed with a liquid medicine.

In the following Tables 1 to 3, the column of the upper side IN indicates the opening/closing state of the valve 2235 provided on the second fluid supply channel unit 2231. The column of the upper side OUT indicates the opening/closing state of the valve 2232 on the particle capturing channel unit 2202. The column of the lower side IN indicates the opening/closing state of the valve 2233 on the first fluid supply channel unit 2203. The column of the lower side OUT indicates the opening/closing state of the valve 2234 on the fluid discharge channel unit 2220.

Further, the suction pressure shown in the upper side OUT represents suction pressure of the pump 2251 connected to the particle capturing channel unit 2202. The suction pressure shown in the lower side OUT represents suction pressure of the pump 2252 connected to the fluid discharge channel unit 2220. The pressure shown in the column of the upper side IN represents pressure applied by the pump 2253 connected to the second fluid supply channel unit 2231. The lower side of the Tables represents the space 2209 on the side on which the particle settles, and the upper side of the Tables represents the space 2210 on the side opposite to the side on which the particle settles.

A series of operations including cell capturing is shown in the following Table 1.

TABLE 1

| | | | Upper side | | Lower side |
|---|---|---|---|---|---|
| | | Upper | OUT | Lower | OUT |
| | | side | (Suction | side | (Suction |
| Step | Operation | IN | pressure) | IN | pressure) |
| 1-1 | Lower side liquid filling | Close | Close | Close | Open |
| | preparation step | | | | (1 kPa) |
| 1-2 | Lower side liquid filling | Close | Close | Open | Open |
| | step | | | | (1 kPa) |
| 1-3 | Upper side liquid filling | Close | Open | Close | Close |
| | preparation step | | (1 kPa) | | |
| 1-4 | Upper side liquid filling | Open | Open | Close | Close |
| | step | | (1 kPa) | | |
| 1-5 | Cell-containing liquid | Close | Close | Open | Close |
| | injecting preparation step | | | | |
| 1-6 | Cell injection and | Close | Open | Open | Close |
| | capturing step | | (0.5 kPa) | | |
| 1-7 | Cell observation step | Close | Open | Open | Close |
| | | | (0.5 kPa) | | |

In Step 1-1, buffer liquid to be filled in the lower side of the chamber is introduced into the container 2623 connected to the first fluid supply channel unit 2203 with the opening/closing state of the valve shown in Table 1.

In Step 1-2, as shown in Table 1, by opening the valve 2233 on the first fluid supply channel unit 2203, the buffer liquid is introduced into the lower side of the chamber.

In Step 1-3, buffer liquid to be filled in the upper side of the chamber is introduced into the container 2243 connected to the second fluid supply channel unit 2231 with the opening/closing state of the valve shown in Table 1.

In Step 1-4, as shown in Table 1, by opening the valve 2235 on the second fluid supply channel unit 2231, the buffer liquid is introduced into the upper side of the chamber.

In Step 1-5, the buffer liquid in the container 2623 connected to the first fluid supply channel unit 2203 is replaced with cell-containing liquid with the opening/closing state of the valve shown in Table 1.

In Step 1-6, suction using the pump 2251 via the particle capturing channel unit 2202 is performed with the opening/closing state of the valve shown in Table 1. In this way, cells are captured in the wells.

In Step 1-7, by maintaining the opening/closing state of the valve in Step 1-6 and continuing the suction via the particle capturing channel unit 2202, the state where the cells are captured in the wells is maintained. The cells are observed while maintaining the state.

A series of operations including processing of the captured cells with a liquid medicine is shown in Table 2.

TABLE 2

| | | | Upper | | Lower |
|---|---|---|---|---|---|
| | | | side | | side |
| | | Upper | OUT | Lower | OUT |
| | | side | (Suction | side | (Suction |
| Step | Operation | IN | pressure) | IN | pressure) |
| 2-1 | Initial cell observation step | Close | Open | Open | Close |
| | | | (0.1 kPa) | | |
| 2-2 | Chemical liquid change | Close | Open | Close | Close |
| | preparation step | | (0.1 kPa) | | |
| 2-3 | Lower side chemical liquid | Close | Open | Open | Close |
| | change step | | (0.1 kPa) | | |
| 2-4 | Flow velocity change step | Close | Open | Open | Close |
| | | | (0.5 kPa) | | |
| 2-5 | Lower side outlet washing | Close | Open | Open | Open |
| | step | | (0.5 kPa) | | (0.2 kPa) |
| 2-6 | Upper side chemical liquid | Open | Open | Open | Open |
| | change step | | (0.5 kPa) | | (0.2 kPa) |
| 2-7 | Upper side chemical liquid | Close | Open | Open | Open |
| | supply stop step | | (0.5 kPa) | | (0.2 kPa) |
| 2-8 | Pre-observation step | Close | Open | Open | Close |
| | | | (0.5 kPa) | | |
| 2-9 | Observation step | Close | Open | Open | Close |
| | | | (0.1 kPa) | | |

Step 2-1 is the same as the above-mentioned Step 1-7.

In Step 2-2, the cell-containing liquid in the container 2623 connected to the first fluid supply channel unit 2203 and the buffer liquid in the container 2243 connected to the second fluid supply channel unit 2231 are replaced with a liquid medicine with the opening/closing state of the valve shown in Table 2. Alternatively, these containers may be replaced with containers containing the liquid medicine.

In Step 2-3, as shown in Table 2, by opening the valve on the first fluid supply channel unit 2203, the liquid on the lower side of the chamber is replaced with the liquid medicine.

In Step 2-4, as shown in Table 2, the suction pressure is changed.

In Step 2-5, as shown in Table 2, by opening the valve 2234 on the fluid discharge channel unit 2220 and performing suction using the pump 2252 connected to the fluid discharge channel unit 2220, the fluid discharge channel unit 2220 is washed.

In Step 2-6, as shown in Table 2, by opening the valve 2235 on the second fluid supply channel unit 2231, the liquid on the upper side of the chamber is replaced with the liquid medicine.

In Step 2-7, as shown in Table 2, by closing the valve on the second fluid supply channel unit 2231, the supply of the liquid medicine to the upper side of the chamber is stopped.

In Step 2-8, as shown in Table 2, the valve 2234 on the fluid discharge channel unit 2220 is closed.

In Step 2-9, the suction force by the particle capturing channel unit 2202 is reduced while maintaining the opening/closing state of the valve in Step 2-8. In this state, cells are observed.

A series of operations including an operation for collecting the processed cells is shown in the following Table 3.

TABLE 3

| | | Upper | Upper | | Lower |
|---|---|---|---|---|---|
| | | side | side | | side |
| | | IN | OUT | Lower | OUT |
| | | (Extrusion | (Suction | side | (Suction |
| Step | Operation | pressure) | pressure) | IN | pressure) |
| 3-1 | Initial cell observation | Close | Open | Open | Close |
| | step | | (0.1 kPa) | | |
| 3-2 | All-valves closing | Close | Close | Open | Close |
| | preparation step | | | | |
| 3-3 | All-valves closing step | Close | Close | Close | Close |
| 3-4 | Upper side buffer | Close | Close | Close | Close |
| | replacement and | | | | |
| | cell collecting | | | | |
| | container connection | | | | |
| | step | | | | |
| 3-5 | Cell discharging step | Open | Close | Close | Close |
| | | (0.5 kPa) | | | |
| 3-6 | Cell collection step | Open | Close | Close | Open |
| | | (0.5 kPa) | | | (0.5 kPa) |
| 3-7 | Cell collection | Open | Close | Close | Close |
| | finishing preparation | (0.5 kPa) | | | |
| | step | | | | |
| 3-8 | Cell collection | Close | Close | Close | Close |
| | finishing step | | | | |
| 3-9 | Stop pump | Close | Close | Close | Close |

Step 3-1 is the same as the above-mentioned Step 2-9.

In Step 3-2, as shown in Table 3, the valve 2232 on the particle capturing channel unit 2202 is closed.

In Step 3-3, as shown in Table 3, the valve 2233 on the first fluid supply channel unit 2203 is closed. Thus, all the valves are closed.

In Step 3-4, as shown in Table 3, the buffer liquid in the container 2243 connected to the second fluid supply channel unit 2231 is replaced with buffer liquid for cell collection with all the valves closed. The buffer liquid for cell collection may be the same as or different from the buffer liquid used in the cell capturing step. Further, the container 2242 connected to the fluid discharge channel unit 2220 is replaced with a cell collection container.

In Step 3-5, as shown in Table 3, the valve 2235 on the second fluid supply channel unit 2231 is opened, and then, pressure is applied to the chamber by the pump 2253 connected to the second fluid supply channel unit 2231. In this way, the cells get out of the wells.

In Step 3-6, as shown in Table 3, the valve 2234 on the fluid discharge channel unit 2220 is opened, and the suction using the pump 2252 connected to the fluid discharge channel unit 2220 is performed. In this way, the cells are collected in the cell collection container.

In Step 3-7, as shown in Table 3, the valve 2234 on the fluid discharge channel unit 2220 is closed.

In Step 3-8, the valve 2235 on the second fluid supply channel unit 2231 is closed. As a result, all the valves are closed.

In Step 3-9, all the pumps are stopped. Through the above-mentioned steps, cells are captured, processed, and collected.

As described above, in the case where the target to be captured is a cell, examples of the buffer liquid include RPMI1640 and DMEM that are culture media. For example, FBS may be added to RPMI1640 and DMEM. The proportion of FBS may be, for example, 1% to 15%, particularly 10%. In the case of observing cells by fluorescent staining, for example, D-PBS(−), Live Cell Imaging Solution (ThermoFisher SCIENTIFIC), or FluoroBrite (Trademark) DMEM (ThermoFisher SCIENTIFIC) with low autofluorescence may be used.

Further, examples of the cell as a target to be captured include a floating cell such as a Jurkat cell, an HL60 cell, and K562, and an adherent cell such as HeLa and MCF-7. The adherent cell may be used after being detached by trypsin treatment to form a single cell, or may be used as a cell cluster. Further, the cell as a target to be captured is not limited to the established cells, and may be, for example, a peripheral blood mononuclear cell (PBMC), an iPS cell, an ES cell, or the like.

Examples of the reagent contained in the liquid medicine processing the cell include, but not limited to, Ethidium Homodimier III, propidium iodide, and calcein AM for conducting cell viability assay, and Phorbol 12-myristate 13-acetate (PMA), and Phytohemagglutinin (PHA) known to active the Jurkat cell.

### (6) Fifth Example of Third Embodiment (Example of Entire Surface Observation at Low Magnification)

In the present disclosure, for example, 10,000 to 100,000 cells can be captured in the wells in the particle capturing chamber, and the captured cells can be observed. As described above, all of these cells in a large number of wells arrayed in a two-dimensional plane cannot be within one field of view of the objective lens of the microscope, for example. In this regard, in order to observe the entire surface of the particle capturing surface, favorably, data on the entire two-dimensional plane may be acquired by an image sensor while moving the observation position of the observation unit (particularly, microscope).

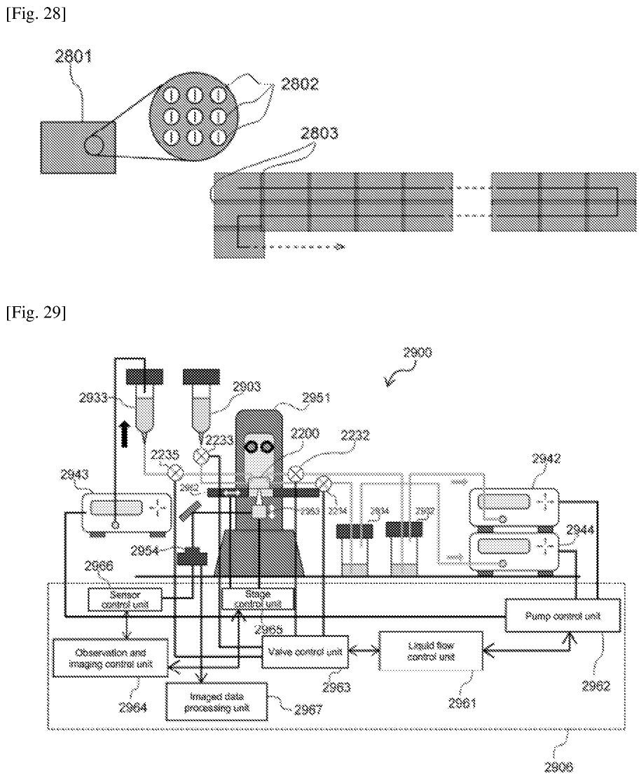

For example, in the case of arranging 40,000 cells in 240×170 at the pitch of 60 μm, the size of the observation surface (i.e., particle capturing surface) is 14.4 mm×10.2 mm. In the case of observing the observation surface with the objective lens having a magnification of 10 times, when one observation surface 2801 within the range of 1.44 mm×0.94 mm shown in FIG. 28 is projected on a CMOS sensor of 24 mm×36 mm, it is necessary to perform stage movement at a distance corresponding to one imaging range approximately 110 times in order to image the entire observation surface. On the observation surface 2801, a plurality of wells 2802 are arrayed in a lattice pattern as shown in FIG. 28.

Since the state of the cell is changed as time passes, it is necessary to image the whole surface at the same time as much as possible in order to compare the differences among many cells. Further, since it is desirable to shorten the imaging cycle in the case of tracking changes over time in the cell in the well, it is very important to efficiently perform the entire surface observation in a short time.

Therefore, in the particle observation step in the method according to the embodiment of the present disclosure, it is favorable to use an objective lens with a wide field of view and low magnification (e.g., less than ×40, particularly ×4 to ×10) in order to observe the entire flat surface on which the cells are captured. Further such entire surface observation can be favorably used for investigating the response to liquid medicine stimulation by fluorescence observation of stained cells.

Specifically, according to the embodiment of the present disclosure, there is provided also an imaging method of making it possible to efficiently observe the entire particle capturing surface in a short time. The imaging method can be performed in the particle observation step described above, for example. A specific example of steps included in the imaging method will be described below. The imaging method described below is also called a tiling method.

(Step 1: Dividing Step)

With the range of one screen imaged by one imaging as one tile, the entire well area of the particle capturing surface is divided into Nx tiles in the X direction and Ny tiles in the Y direction. Finally, Nx×Ny pieces of imaging data are acquired.

In order to check the imaging position of the imaging data after the imaging, for example, it is favorable to provide a position marker indicating the coordinates on the well area.

Further, in order to image all wells without loss, each tile may include a predetermined overlap area at the end thereof upon the tile division. The overlap area is, for example, an area 2803 shown in FIG. 28. The overlap area may, for example, cover several wells (2, 3, 4, or 5 wells). By referring to the position marker, it is possible to accurately detect the overlap area on the imaging data.

(Step 2: Imaging Step)

For example, as shown in FIG. 28, the imaging is started from the uppermost tiles in the Y direction, and Nx tiles are consecutively imaged from the left end to the right end in the X direction.

(Step 3: Imaging Step)

The imaging position goes down one line in the Y direction while keeping the position in the X direction, and Nx tiles are imaged in the direction opposite to that in Step 2 from the right end to the left end in the X direction.

(Step 4: Imaging Step)

Similarly to Step 3, the imaging position goes down one line in the Y direction while keeping the position in the X direction, and Nx tiles are imaged in the same direction as that in Step 2 from the right end to the left end in the X direction.

(Step 5: Repeating Step)

Steps 2 to 4 are repeated until the imaging position goes down to the Ny-th line in the Y direction.

(Step 6: Image Combining Step)

By combining the imaging data acquired in Steps 2 to 5, the entire screen imaging data is acquired. In the combining, it is possible to acquire more accurate data at higher speed by referring to the position marker described in Step 1.

(Step 7: Repeating Step)

In the case of observing the changes over time in the cell captured in the well, Steps 2 to 6 are repeated a plurality of cycles until a predetermined time has elapsed.

In the case of performing the above-mentioned imaging method, actually, deflection is present in the particle capturing surface (resin chip), or the particle capturing surface is inclined when the particle capturing chip is disposed in the chamber in some cases. For that reason, in the case of observing a wide range, favorably, focus adjustment can be performed at any time for each tile. Therefore, the imaging apparatus that performs imaging favorably has an autofocus function.

Further, all of the areas to be captured are desirably within the focal depth. Therefore, the apparatus mounting accuracy of the particle capturing chip (or cartridge including the particle capturing chip) is desirably guaranteed so that all of the particle capturing surface is within the focal depth when the particle capturing chip is set to the apparatus. Alternatively, initial adjustment is favorably performed so that all of the particle capturing surface is within the focal depth when the particle capturing chip (or cartridge including the particle capturing chip) is set to the apparatus.

For example, in the case of performing observation with an objective lens having a magnification of 10 times and NA=0.25, the focal depth is approximately ±5 μm. Therefore, it is desirable that the surface change is within the focal depth range within the imaging range of 1.5 mm×1.0 mm.

For example, in the case of performing the above-mentioned Steps 1 to 6, the time necessary for imaging the entire particle capturing surface is a sum of (1) an inter-tile stage moving time, (2) an imaging time, and (3) a focusing time. Therefore, in the case where the time necessary for imaging one tile is 1 to 2 seconds, it takes approximately 3 minutes for one cycle to scan the above-mentioned 40,000 cells arranged in the range of 14.4 mm×10.2 mm.

### (7) Sixth Example of Third Embodiment (Example of Three-Dimensional Observation at High Magnification)

In order to acquire detailed information regarding the shape and/or internal structure of the cell, for example, an objective lens with a high magnification such as ×40 to ×60 is suitable. Since the objective lens with a high magnification has a narrow field of view, it is not suitable for the entire surface observation. In this regard, for example, by the observation method described in “(6) Fifth Example of Third Embodiment (Example of Entire Surface Observation at Low Magnification)”, several cells showing interesting results are selected from the cells screened on the entire surface with a low magnification lens, and detailed information regarding the cells can be acquired by cell observation using an objective lens with a high magnification, such as phase difference observation and fluorescence observation.

In the case of performing observation with a high magnification lens with NA of not less than 0.6, the focal depth is less than ±1 μm. Therefore, a three-dimensional image of the entire cell can be acquired by, for example, repeatedly imaging the same cell, e.g., cell having a diameter of 5 to 30 μm while moving the sample stage or the objective lens in the focal direction at intervals of 1 μm and performing image processing on the acquired pieces of imaging data.

As described above, in accordance with the present disclosure, in the particle observation step, cell observation can be performed with a high magnification lens. Further, in accordance with the present disclosure, in the particle observation step, imaging using a high magnification lens can be performed a plurality of times. Further, by combining images acquired by the plurality of times of imaging, a three-dimensional image of a particle (e.g., cell) can be acquired.

### 4. Fourth Embodiment (Apparatus)

### (1) Description of Fourth Embodiment

According to an embodiment of the present disclosure, there is provided also an apparatus including: a particle capturing chamber including at least a particle capturing unit including one of at least one well or at least one through hole, and a particle capturing channel unit used for capturing a particle in the well or with the through hole; and a sucking unit that performs suction via the particle capturing channel unit, in which the particle capturing chamber is configured to capture the particle in the well or with the through hole by sucking the particle to the side opposite to the side on which the particle settles. Since the particle capturing chamber is as described in “1. First Embodiment (Particle Capturing Chamber)”, description of the chamber is omitted.

The apparatus according to the embodiment of the present disclosure only needs to include the particle capturing chamber according to the embodiment of the present disclosure, and be capable of capturing a particle in the chamber, and may be, for example, a particle capturing apparatus or particle analyzing apparatus.

The apparatus according to the embodiment of the present disclosure includes a sucking unit that performs sucks via the particle capturing channel unit. With the sucking unit, the particle can be sucked to the side opposite to the side on which the particle settles. The sucking unit can be a pump known to those skilled in the art. The pump used in the embodiment of the present disclosure is favorably a pump capable finely adjusting the suction force, more favorably a pump capable of controlling the pressure in the order of tens of Pa at around 1 kPa. Such a pump is commercially available, and examples of the pump include KAL-200 (Halstrup-Walcher Group).

### (2) Example of Fourth Embodiment (Apparatus)

An example of the apparatus according to the embodiment of the present disclosure will be described with reference to FIG. 12. FIG. 12 is a block diagram of an example of the apparatus according to the embodiment of the present disclosure.

As shown in FIG. 12, an apparatus 1200 according to the embodiment of the present disclosure includes a particle capturing chamber 1201, a sucking unit 1202, a fluid supply unit 1203, a fluid collecting unit 1204, an observing unit 1205, a control unit 1206, and an analysis unit 1207.

The particle capturing chamber 1201 includes a particle capturing unit including one of at least one well or at least one through hole, and a particle capturing channel unit used for capturing a particle in the well or with the through hole. The particle is captured in the well or with the through hole by being sucked, via the particle capturing channel unit, to the side opposite to the side on which the particle settles. The particle capturing chamber 1201 further includes a fluid supply channel unit and a fluid discharge channel unit.

As described above, the particle capturing unit may be replaceable. A particle capturing chip in the particle capturing chamber 1201 may be detachably provided from the chamber. Further, for example, for each analysis, a user may replace the particle capturing chip.

Alternatively, the particle capturing chamber 1201 itself may be replaceable. Specifically, the particle capturing chamber 1201 may be detachably provided in the apparatus 1200 according to the embodiment of the present disclosure. For example, in accordance with the present disclosure, a cartridge-like particle capturing chamber unit in which the particle capturing chip and a chip holder holding the chip are integrated may be detachably provided in the apparatus 1200 according to the embodiment of the present disclosure. In this case, since the user is capable of replacing the particle capturing unit by replacing the cartridge, it is easier to handle it as compared with the case of replacing only the particle capturing unit that is a small thin film. Further, in this case, since the inside of the chamber is not exposed, it is possible to prevent dust from attaching to the wells.

The sucking unit 1202 sucks particles in the chamber via the particle capturing channel unit of the particle capturing chamber 1201. For example, the suction in the particle capturing step described in “3. Third Embodiment (Particle Capturing Method)” is performed. The sucking unit 1202 can be connected to the particle capturing chamber 1201 so as to be capable of performing the suction. For example, the particle capturing channel of the particle capturing channel unit and the pipe of the sucking unit 1202 for performing suction can be communicated with each other. On the pipe, a valve may be provided. The sucking unit includes, for example, a pump. Further, for example, as shown in FIG. 5, the sucking unit 1202 can be connected to the particle capturing chamber 1201 via a liquid collection container so that the sucked liquid does not enter the pump. The sucking unit 1202 can be communicated with a space on the side opposite to the side on which the particle settles among spaces in the particle capturing chamber 1201.

The fluid supply unit 1203 supplies fluid containing particles to the particle capturing chamber 1201. For example, in the particle capturing step described in “3. Third Embodiment (Particle Capturing Method)”, the fluid supply unit 1203 is used for supplying the fluid containing particles to the particle capturing chamber by suction. The fluid supply unit includes, for example, a container capable of storing the fluid containing particles, and a pipe connected to the container. The pipe can be communicated with the fluid supply channel of the fluid supply channel unit of the particle capturing chamber 1201. On the pipe, a valve may be provided. The fluid supply unit 1203 can be communicated with the space on the side on which the particle settles among spaces in the particle capturing chamber 1201.

The fluid collecting unit 1204 collects the fluid from the particle capturing chamber 1201. For example, the fluid collecting unit 1204 performs the particle removal in the removing step described in “3. Third Embodiment (Particle Capturing Method)”. The fluid collecting unit 1204 can be connected to the particle capturing chamber 1201 so as to be capable of collecting the fluid from the particle capturing chamber 1201. For example, the fluid discharge channel of the particle capturing chamber 1201 and a pipe of the fluid collecting unit 1204 for collecting fluid can be communicated with each other. On the pipe, a valve may be provided. The fluid collecting unit 1204 includes, for example, a pump. The fluid in the chamber is collected by suction using the pump. For example, as shown in FIG. 11, the fluid collecting unit 1204 can be connected to the particle capturing chamber 1201 via the liquid collection container so that the liquid sucked by the fluid collecting unit does not enter the pump. The fluid collecting unit 1204 can be communicated with the space on the side on which the particle settles among spaces in the particle capturing chamber 1201.

The particle capturing chamber 1201 may include one, two, or three or more fluid collecting units 1204. For example, in the case where the particle capturing chamber 1201 includes two fluid collecting units, one fluid collecting unit is used for collecting particles that are not captured in the well or with the through hole, and the other fluid collecting unit is used for collecting particles captured in the well or with the through hole.

The observing unit 1205 is used for observing the particles captured in the well or with the through hole and/or knowing characteristics of the particles captured in the well or with the through hole. The observation of particles can be, for example, observation of the shape, structure, and/or color of the particle itself. Knowing the characteristics of particles can be, for example, knowing the wavelength and/or intensity of light emitted from the particles, such as fluorescence. The observing unit 1205 may be an apparatus that enables the above-mentioned observation and/or knowing, and may be, for example, a microscope and/or a photodetector. In the present disclosure, since the particles are captured in the well or with the through hole by being sucked to the side opposite to the side on which the particle settles, the observing unit 1205 is favorably configured to be capable of observing the captured particles via the space on the side on which the particle settles. For example, the observing unit 1205 can be provided below the particle capturing chamber 1201. In order to make it easy to observe the particles from the side on which the particle settles, for example, an inverted microscope is favorably used as the microscope. Further, favorably, the microscope can be an optical microscope. Specifically, in the present disclosure, favorably, the observing unit 1205 includes an inverted optical microscope.

In order to observe the external characteristics of the cell, bright field observation or dark field observation, which is generally adopted, may be adopted also in the present disclosure. Further, in the case of observing a transparent cell with the fine internal structure of the cell emphasized, phase difference observation or differential interference observation suitable for such a case may be adopted in the present disclosure. By adopting these observation methods, it is possible to observe living cells without staining them. In order to observe a transparent cell, particularly, phase difference observation is favorably adopted. In the case of adopting phase difference observation, the observing unit 1205 favorably includes a halogen lamp light source, an objective lens, a phase plate, a condenser lens, and a ring stop.

Further, by labelling cells with fluorescent proteins, it is possible to observe the cells under fluorescence observation with the specific part of interest in the cell emphasized. Such fluorescence observation is used in various applications such as identification of an antigen by antigen-antibody reaction and visualization of intracellular structure such as a mitochondrion. In the case of performing fluorescence observation, the observing unit 1205 favorably includes an excitation light source (generally, mercury lamp), a filter for selecting a wavelength of excitation light, a dichroic mirror for extracting the fluorescence of the wavelength emitted from a substance, and an absorption filter that cuts off wavelengths other than the fluorescence wavelength. Various types of analysis can be performed from one observation image by selecting a combination of an excitation wavelength and a fluorescence wavelength by using the filter. Further, the observing unit 1205 can further include an imaging apparatus. Examples of the imaging apparatus include an imaging apparatus including an image sensor, particularly digital camera. The image sensor can be, for example, a CCD (Charge Coupled Device) or a CMOS (Complementary Metal Oxide Semiconductor). The image data acquired by imaging may be stored in the imaging apparatus, the analysis unit 1207, or an external data storage apparatus wired or wirelessly connected to the imaging apparatus.

The control unit 1206 can control the sucking unit 1202, the fluid supply unit 1203, and/or the fluid collecting unit 1204. For example, the control unit 1206 can control pumps and/or valves of the sucking unit 1202, the fluid supply unit 1203, and/or the fluid collecting unit 1204. In this way, various steps in the particle capturing method according to the embodiment of the present disclosure such as the particle capturing step, the particle removing step, and the particle collecting step are performed.

The analysis unit 1207 analyzes the data acquired by the observing unit 1205, e.g., image data or data regarding light. For example, the analysis unit 1207 performs the analysis in the analyzing step described in “3. Third Embodiment (Particle Capturing Method)”. The analysis unit 1207 can select a particle having a predetermined shape or color on the basis of, for example, the acquired image data, or can select a particle that emits predetermined fluorescence on the basis of the acquired data regarding light. The positional information regarding the selected particle can be transmitted to, for example, a single particle capturing apparatus such as a micromanipulator wired or wirelessly connected to the analysis unit 1207. On the basis of the positional information, the selected particle can be independently acquired by the single particle capturing apparatus.

The apparatus 1200 may include, in addition to the above-mentioned components, other components, e.g., the above-mentioned single particle capturing apparatus. Further, the apparatus 1200 may include, as necessary, a storage unit that stores various types of data, an input unit that inputs an instruction regarding particle capturing from a user, an output unit that outputs various results such as a capturing result and an analysis result, and the like.

### (3) Another Example of Fourth Embodiment (Apparatus)

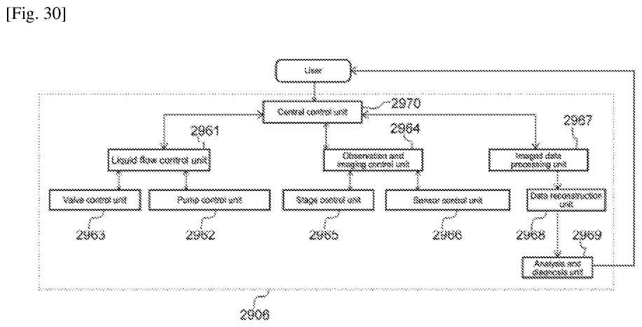

Another example of the apparatus according to the embodiment of the present disclosure will be described with reference to FIGS. 29 and 30. FIG. 29 shows a configuration example of the apparatus according to the embodiment of the present disclosure. FIG. 30 is a block diagram showing an example of a control unit included in the apparatus.

An apparatus 2900 according to the embodiment of the present disclosure shown in FIG. 29 includes the particle capturing chamber 2200 described in “(14) Thirteenth Example of First Embodiment (Particle Capturing Chamber)”. The particle capturing chamber 2200 includes the chip and the chip holder as described in 2. “(3) Another Example of Second Embodiment (Example of Chip and Chip holder)”.

Among the components of the particle capturing chamber 2200, to the first fluid supply channel unit 2203, a liquid supply tank 2903 is connected as the fluid supply unit via the valve 2233.

Further, to the second fluid supply channel unit 2231, a liquid supply tank 2933 is connected via the valve 2235. To the liquid supply tank 2933, a micro pressure pump 2943 is connected. By driving the micro pressure pump 2943, it is possible to supply fluid to the particle capturing chamber 2200.

To the particle capturing channel unit 2202, a waste liquid tank 2932 and a micro pressure pump 2942 are connected via the valve 2232.

To the fluid discharge channel unit 2220, a waste liquid tank 2934 and a micro pressure pump 2944 are connected via the valve 2234. The waste liquid tank 2934 can be replaced with, for example, a particle collecting tank in order to collect particles. These valves are favorably electrically operated pinch valves. Further, these micro pressure pumps are favorably capable of adjusting the pressure between 10 Pa to 3000 Pa, more favorably 100 Pa to 2000 Pa, in the order of, for example, 100 to 1000 Pa, favorably 10 Pa to 300 Pa, more favorably 20 Pa to 200 Pa.

The particle capturing chamber 2200 is disposed on a stage 2952 of an inverted microscope 2951. The stage 2952 can be moved by electrical control in, for example, the X direction and the Y direction.

An objective lens 2953 of the inverted microscope 2951 can be moved by electrical control in, for example, the Z direction. The objective lens 2953 is configured to be capable of observing the particle capturing surface of the particle capturing chamber 2200 from below the particle capturing chamber 2200.

The inverted microscope 2951 may include, for example, a light source (such as a halogen lamp, a mercury lamp, LED, or the like), a filter (such as an excitation filter and/or a fluorescent filter), an objective lens having a magnification according to the purpose, an electric XY stage, and an electric Z stage (which may move the objective lens, or on which the chamber may be disposed).

To the inverted microscope 2951, a camera 2954 is connected. The camera 2954 is configured to be capable of imaging the particle capturing surface of the particle capturing chamber 2200 via the objective lens 2953. The camera 2954 includes, for example, a CMOS image sensor or a CCD image sensor. The camera 2954 is configured to be capable of transmitting the imaged data to an imaged data processing unit described below.

The apparatus 2900 includes a control unit 2906. The control unit 2906 includes a liquid flow control unit 2961, a pump control unit 2962, a valve control unit 2963, an observation and imaging control unit 2964, a stage control unit 2965, a sensor control unit 2966, and an imaged data processing unit 2967.

The liquid flow control unit 2961 controls supply of fluid to the particle capturing chamber 2200 or discharge of the fluid from the particle capturing chamber 2200 by controlling the pump control unit 2962 and the valve control unit 2963. The liquid flow control unit 2961 controls, for example, cell capturing, replacement of a liquid medicine, and/or cell collection.

The pump control unit 2962 controls the operation of the micro pressure pump and/or the differential pressure applied by the micro pressure pump.

The valve control unit 2963 controls the opening and closing of the valve.

The observation and imaging control unit 2964 images the particle capturing surface by controlling the stage control unit 2965 and the sensor control unit 2966. For example, the observation and imaging control unit 2964 controls the stage control unit 2965 and the sensor control unit 2966 to perform the imaging described in 3. “(6) Fifth Example of Third Embodiment (Example of Entire Surface Observation at Low Magnification)” or “(7) Sixth Example of Third Embodiment (Example of Three-Dimensional Observation at High Magnification)”. For example, cell imaging at a low magnification can be performed while moving the electric XY stage over a wide range in well areas divided into tiles. Further, each imaging can be performed after stopping the electric XY stage and then moving the electric Z stage to perform focus adjustment. Further, in cell imaging at a high magnification, one cell is imaged at a plurality of positions in the Z direction or a plurality of focal positions. The stage control unit 2965 controls the stage 2952 and/or the objective lens 2953. By the stage control unit 2965, the area to be imaged can be moved and/or focus adjustment can be performed.

The sensor control unit 2966 controls the camera 2954. By the sensor control unit 2966, for example, the timing of imaging the particle capturing surface, the exposure period, and/or the number of times of imaging can be controlled.

By the observation and imaging control unit 2964, the stage control by the stage control unit 2965 and the camera operation control by the sensor control unit 2966 can be synchronized. Further, the observation and imaging control unit 2964 can control the rotation of the electric revolver to which a plurality of objective lenses 2953 are attached. Specifically, the observation and imaging control unit 2964 is capable of switching the objective lenses 2953.

The imaged data processing unit 2967 processes the image data transmitted from the camera 2954. For example, the imaged data processing unit 2967 can acquire image data of the entire two-dimensional plane by combining a plurality of pieces of imaged data as described in 3. “(6) Fifth Example of Third Embodiment (Example of Entire Surface Observation at Low Magnification)”. Further, the imaged data processing unit can acquire a three-dimensional image of a particle as described in 3. “(7) Sixth Example of Third Embodiment (Example of Three-Dimensional Observation at High Magnification)”, for example. As described above, the imaged data processing unit can obtain a two-dimensional image by arranging a plurality of pieces of in-XY plane imaged data, or acquire a three-dimensional image by combining pieces of data of one cell imaged by slicing in the Z direction.

The image data of the entire two-dimensional plane or three-dimensional image of a particle may be acquired by the data reconstruction unit 2968 other than the imaged data processing unit 2967 as shown in FIG. 30.

Further, the control unit 2906 may include the analysis and diagnosis unit 2969 as shown in FIG. 30. The analysis and diagnosis unit 2969 can analyze and/or diagnose the particle on the basis of the imaged data acquired by the imaged data processing unit 2967 or the data reconstruction unit 2968. For example, the analysis and diagnosis unit 2969 can extract the shape of the particle and/or analyze the fluorescence intensity on the basis of the imaged data. The data acquired as a result of the analysis may be presented to a user via an output apparatus such as a display. As a result, it is possible to assist the user to analyze and/or diagnose the particle.

As shown in the block part of FIG. 30, the liquid flow control unit 2961, the observation and imaging control unit 2964, and the imaged data processing unit 2967 may be controlled by the central control unit 2970. When the user designates an operation to be performed by the apparatus to the central control unit 2970, the central control unit 2970 can control the liquid flow control unit 2961, the observation and imaging control unit 2964, and the imaged data processing unit 2967.

### 5. Fifth Embodiment (Particle Analysis System)

### (1) Description of Fifth Embodiment

According to an embodiment of the present disclosure, there is provided also a particle analysis system, including: a particle capturing chamber including at least a particle capturing unit including one of at least one well or at least one through hole, and a particle capturing channel unit used for capturing a particle in the well or with the through hole; a sucking unit that performs suction via the particle capturing channel unit; and an analysis unit that analyzes the particle captured by the chamber, in which the particle capturing chamber is configured to capture the particle in the well or with the through hole by sucking the particle to the side opposite to the side on which the particle settles.

Since the particle capturing chamber is as described in “1. First Embodiment (Particle Capturing Chamber)”, description of the chamber is omitted.

Since the sucking unit is as described in “4. Fourth Embodiment (Apparatus)”, description of the sucking unit is omitted.

### (2) Example of Fifth Embodiment (Particle Analysis System)

The particle analysis system according to the embodiment of the present disclosure can include, for example, the particle capturing chamber 1201, the sucking unit 1202, and the analysis unit 1207 described in “4. Fourth Embodiment (Apparatus)” with reference to FIG. 12. In the particle analysis system according to the embodiment of the present disclosure, these components can be configured to be capable of performing the particle capturing method according to the embodiment of the present disclosure and the analysis of the captured particles. These components do not necessarily need to be provided in one apparatus, and may be provided in, for example, separate apparatuses. The particle analysis system according to the embodiment of the present disclosure can further include the fluid supply unit 1203, the fluid collecting unit 1204, the observing unit 1205, the control unit 1206, and/or the single particle obtaining apparatus described in “4. Fourth Embodiment (Apparatus)” with reference to FIG. 12. Further, the particle analysis system according to the embodiment of the present disclosure can include, as necessary, a storage unit, an input unit, an output unit, and the like.

### (3) Another Example of Fifth Embodiment (Particle Analysis System)

The particle analysis system according to the embodiment of the present disclosure can include, for example, the particle capturing chamber 2200, the pump connected to the particle capturing channel unit 2202, and the control unit described in 1. “(14) Thirteenth Example of First Embodiment (Particle Capturing Chamber)”. In the particle analysis system according to the embodiment of the present disclosure, these components can be configured to be capable of performing the particle capturing method according to the embodiment of the present disclosure and the analysis of the captured particles. These components do not necessarily need to be provided in one apparatus, and may be provided in, for example, separate apparatuses.

Regarding the present disclosure described above, those skilled in the art will appreciate that various modifications, combinations, sub-combinations, or alternatives can be made within the scope of the present disclosure and its equivalents according to, for example, design requirements, other factors, or the like.

### 6. Example

### (1) Comparative Example 1

### a. Apparatus Used in Comparative Example 1

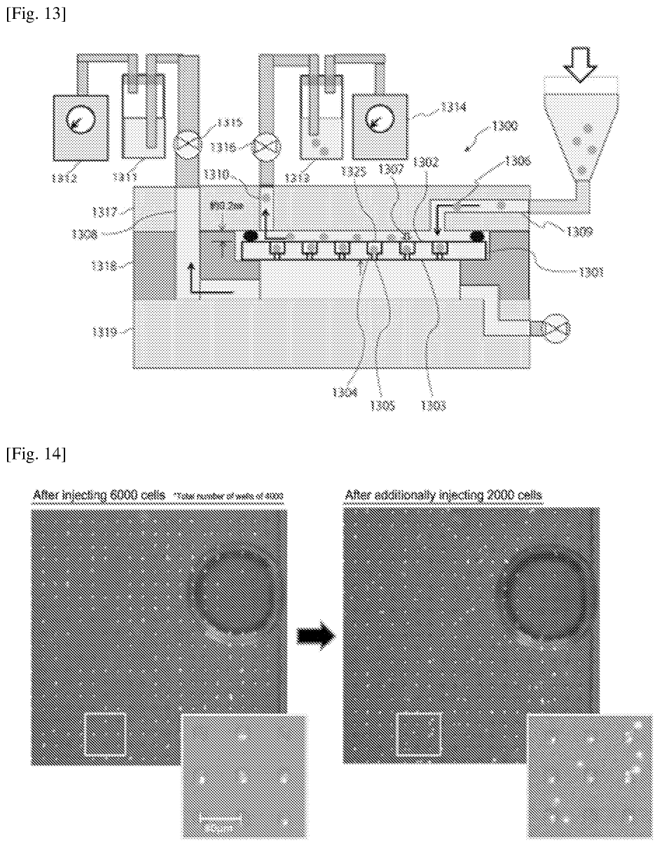

A particle capturing chamber that captures a particle in a well by sucking the particle to the direction in which the particle settles (hereinafter, referred to as chamber of the comparative example 1) is prepared. A schematic diagram of the chamber of the comparative example 1 is shown in FIG. 13.

As shown in FIG. 13, a particle capturing chamber 1300 includes a particle capturing unit 1301 therein. The particle capturing unit 1301 has a particle capturing surface 1302 and a surface 1303 facing the side opposite thereto. The particle capturing surface 1302 includes a plurality of wells 1325. A hole 1305 is provided at the bottom 1304 of each of the wells. The hole 1305 extends from the bottom 1304 to the surface 1303 facing the opposite side. The chamber 1300 is disposed so that gravity acts on particles 1306 in the direction indicated by an arrow 1307. Each of the wells 1325 has a dimension in which only one particle 1306 captured.

The particle capturing chamber 1300 includes a particle capturing channel unit 1308, a fluid supply channel unit 1309, and a fluid discharge channel unit 1310. To the particle capturing channel unit 1308, a pump 1312 is connected via a liquid collection container 1311. Similarly, to the fluid discharge channel unit 1310, a pump 1314 is connected via a liquid collection container 1313. A valve 1315 is provided to the tip of the particle capturing channel unit 1308. Similarly, a valve 1316 is provided to the tip of the fluid discharge channel unit.

In the particle capturing chamber 1300, a first member 1317, a second member 1318, and a third member 1319 form spaces in the chamber and channels.

The particle capturing unit 1301 was produced by a 3D stereolithography process using PMMA-based UV curable resin as a material. In the particle capturing unit 1301, 63×63=approximately 4000 microwells are formed in the range of a square of 5 mm×5 mm. The wells are arranged in a lattice pattern as shown in FIG. 8. The opening of each of the wells had a circular shape with a diameter of 20 μm, and the depth of the well was 20 μm. The intervals between the wells are approximately 80 μm in the X direction and the Y direction. The opening of the hole 1305 had a slit shape with a width of 5 μm×length of 10 μm, and the depth of the hole 1305 was 15 μm.

The first member 1317 was formed of transparent borosilicate cover glass. It is possible to observe the inside of the well via the first member 1317.

The second member 1318 was formed of three-layer PDMS sheets. The second member 1318 was created by providing channel patterns for forming the channels shown in FIG. 13 in the three-layer PDMS sheets and stacking these sheets.

The third member 1319 was an acrylic plate.

Channel patterns were formed in advance in the borosilicate cover glass forming the first member 1317, the three PDMS sheets forming the second member 1318, and the acrylic plate forming the third member 1319 so that the channels and the spaces in the chamber shown in FIG. 13 were formed when they were stacked.

The three PDMS sheets and the acrylic plate on which the channel patterns were formed were stacked. Next, the particle capturing unit 1301 was disposed to divide the space in the chamber into two spaces of the upper space and the lower space. The area in which the wells are provided of the particle capturing unit 1301 was surrounded by a flexible PDMS sheet. Finally, the cover glass was stacked to create the particle capturing chamber 1300.

By sealing the gap between the cover glass and the PDMS sheet with the PDMS sheet surrounding the area in which the wells are provided, it was ensured that the liquid did not move in and out of the two spaces via a part other than the hole.

The distance between the particle capturing surface 1302 in the chamber 1300 and the ceiling of the chamber was approximately 0.2 mm.

As the pumps 1312 and 1314, a pressure calibrator KAL-200 (Halstrup-Walcher Group) was used. This apparatus is capable of controlling the micro pressure in the order of several tens of Pa. The pumps 1312 and 1314 were respectively connected to the particle capturing channel unit 1308 and the fluid discharge channel unit 1310 by a PEEK tube with an inner diameter of 1 mm.

### b. Particle Capturing

Only the valve 1315 was opened. Next, K562 cells (human chronic myelogenous leukemia cells) each having a particle size of 15±5 μm were injected into the chamber 1300 via the fluid supply channel unit 1309 while performing suction with a differential pressure of 0.6 kPa using the pump 1312.

When 6000 cells were injected into the chamber 1300, cells were captured in 2200 wells among approximately 4000 wells. Further, the number of cells that have settled outside the wells was 60 to 70. Other cells passed through the holes, or settled in the fluid supply channel unit 1309. The state of the cell capturing on the particle capturing surface after injecting 6000 cells is shown in the photograph on the left side of FIG. 14.

Further, when 2000 cells were additionally injected into the chamber 1300, the number of wells that have captured cells reached 2900, but the number of cells that have settled outside the wells was increased to 600 to 700. Since the number of cells that have settled was large, observation of the cells captured in the wells was interfered. The state of the cell capturing on the particle capturing surface after additionally injecting 2000 cells is shown in the photograph on the right side of FIG. 14.

When comparing the photograph on the left side and the photograph on the right side in FIG. 14, it can be seen that the number of wells that have captured particles is larger in the photograph on the right side. However, in the photograph on the right side, the number of observed cells that have settled around the wells is also large.

### c. Particle Removing

Next, attempts were made to remove the cells that have settled around the wells. For the removal, the valve 1316 was opened. As described below, the removal was performed by generating liquid flow around the particle capturing surface by suction using the pump 1314 connected to the fluid discharge channel unit 1310.

First, in order to prevent the cells captured in the wells from getting out of the wells by the liquid flow, suction of 0.3 kPa using the pump 1312 was started to hold the cells in the wells.

Next, by gradually increasing the suction pressure by the pump 1314 from zero while performing the holding, liquid flow was generated around the particle capturing surface. In the case where the suction force by the pump 1314 was around 1 kPa, the cells that have settled around the wells did not move at all. When the suction pressure by the pump 1314 was increased to 1.5 kPa, a part of the cells that have settled around the wells started to slightly move. When the suction pressure by the pump 1314 was increased to 2 kPa, cells captured in the wells in addition to the cells that have settled around the wells began to flow to the fluid discharge channel unit 1310. Further, some of the cells that have settled around the wells did not flow to the fluid discharge channel unit 1310 even by the suction pressure of 2 kPa. As described above, it was difficult to control the liquid flow, i.e., suction pressure for discharging only the cells that have settled around the wells from the chamber.

Further, when the suction pressure by the pump 1314 was increased to 3 kPa, 20 to 30% of the cells captured in the wells flowed to the fluid discharge channel unit 1310. Meanwhile, some of the cells that have settled around the wells still did not flow to the fluid discharge channel unit 1310 even by the suction pressure of 3 kPa. In particular, it was the most difficult to remove cells adhered to the cells captured in the wells. In FIG. 15, the state where other cells were adhered to the cells captured in the wells is shown.

As described above, in the chamber of the comparative example 1, it was difficult to remove the cells that have settled around the wells.

### (2) Example 1

### a. Apparatus Used in Example 1

A particle capturing chamber that captures a particle in a well by sucking the particle to a side opposite to a side on which the particle settles (hereinafter, referred to also as “chamber of the example 1” was prepared. A schematic diagram of the chamber of the example 1 is as described in FIG. 5 described in (5) of “1. First Embodiment (Particle Capturing Chamber)”. Therefore, description of the configuration of the chamber of the example 1 is omitted. Hereinafter, the material of the member constituting the chamber of the example 1 and the method of producing the same will be described.

As the particle capturing unit 501, the same one as the particle capturing unit 1301 used in the comparative example 1 was used.

The first member 517 was an acrylic plate.

The second member 518 was formed of three-layer PDMS sheets. The second member 518 was created by providing channel patterns for forming the channels shown in FIG. 5 in the three-layer PDMS sheets and stacking these sheets.

The third member 519 was formed of a transparent borosilicate cover glass. Therefore, it is possible to observe the inside of the well via the third member 519. Channel patterns were formed in advance in the acrylic plate forming the first member 517, the three PDMS sheets forming the second member 518, and the borosilicate cover glass forming the third member 519 so that the channels and the spaces in the chamber shown in FIG. 5 were formed when they were stacked.

The borosilicate cover glass and the three PDMS sheets on which the channel patterns were formed were stacked. Next, the particle capturing unit 501 was disposed to divide the space in the chamber into two spaces of the upper space and the lower space. The area in which the wells are provided of the particle capturing unit 501 was surrounded by a flexible PDMS sheet. Finally, the acrylic plate was stacked to create the cell capturing chamber 500.

By sealing the gap between the cover glass and the PDMS sheet with the PDMS sheet surrounding the area in which the wells are provided, it was ensured that the liquid did not move in and out of the two spaces via a part other than the hole. The distance between the particle capturing surface 502 in the chamber 500 and the bottom surface of the chamber was approximately 0.3 mm.

As the pumps 512 and 514, a pressure calibrator KAL-200 (Halstrup-Walcher Group) was used. The pumps 512 and 514 were respectively connected to the particle capturing channel unit 508 and the fluid discharge channel unit 510 by a PEEK tube with an inner diameter of 1 mm.

### b. Particle Capturing

Only the valve 515 was opened. Next, by performing suction with a differential pressure of 0.6 kPa using the pump 512, 5000 K562 cells that are the same as those used in the comparative example 1 were injected from the container 523 into the chamber 500 via the fluid supply channel unit 509. In this case, substantially all of the injected cells settled on the bottom surface of the chamber. The number of cells captured in the wells was less than 10. It was conceivable that the suction force of 0.6 kPa was insufficient to cause the cells to float in the chamber 500.

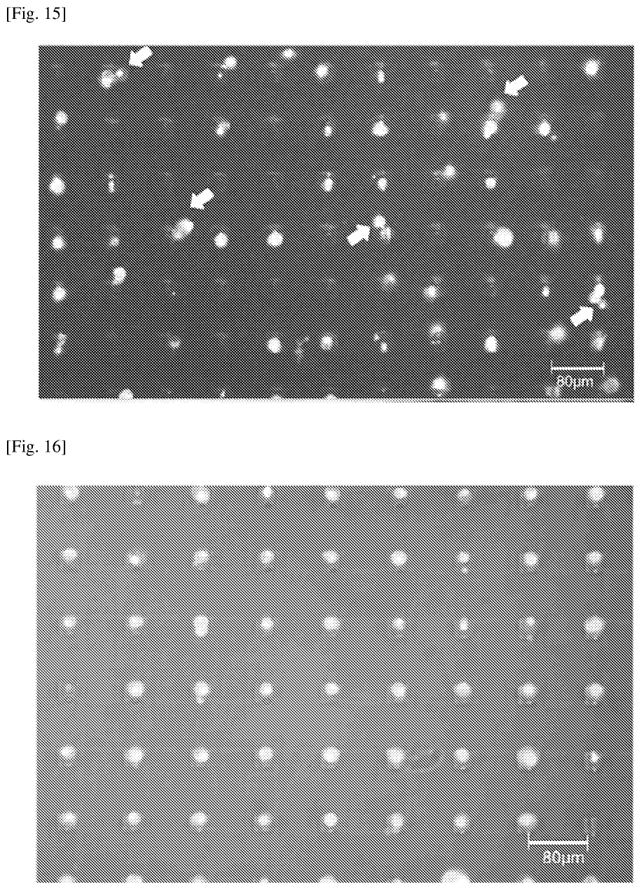

Next, 5000 K562 cells were injected into the chamber 500 via the fluid supply channel unit 509 while performing suction with a differential pressure of 1.1 kPa using the pump 512. As a result, cells were captured in 2800 wells among approximately 4000 wells. Specifically, cells were captured in approximately 70% of the wells. Further, the number of cells attached to the vicinity of the wells on the particle capturing surface was approximately 20. In FIG. 16, a photograph of the particle capturing surface on which particles are captured. The particles that have not been captured in the wells settled on the bottom surface of the chamber.

As described above, in the chamber of the example 1, favorable results that cells were captured in 2800 wells corresponding to approximately 70% of the total 4000 wells were achieved.

Further, the number of cells attached to the vicinity of the wells was extremely small, i.e., approximately 20. Therefore, it is unnecessary to remove the cells attached to the vicinity of the wells before observing the cells captured in the wells.

Further, in the chamber of the example 1, by injecting 5000 cells, cell capturing in 2800 wells was achieved. Meanwhile, in the chamber of the comparative example 1, in order to capture cells in the same number of wells, it was necessary to inject a total of 8000 cells. Therefore, in the chamber of the example 1, it was possible to capture the same number of cells in the wells by injecting a smaller number of cells, as compared with the case of the chamber of the comparative example 1.

Further, in the chamber of the example 1, the number of cells attached to the vicinity of the wells in the case where cell capturing in 2800 wells was achieved was approximately 20. Meanwhile, in the chamber of the comparative example 1, the number of cells that have settled outside the wells in the case where cell capturing in the same number of wells was achieved was 600 to 700. In other words, in the chamber of the example 1, the number of cells attached to the vicinity of the wells in capturing the same number of cells in the wells was extremely small, as compared with the case of the chamber of the comparative example 1. Therefore, in the chamber of the example 1, it is not necessary to remove the cells attached to the vicinity of the wells before observing the cells captured in the wells unlike the case of using the chamber of the comparative example 1.

After the cell capturing, the valve 515 was closed to stop the suction. The captured cells did not naturally fall and were held in the wells. Next, when the valve 515 was opened again and pressure is applied in the opposite direction to generate back flow, the cells did not get out of the wells until the counter pressure reached 2 kPa. Specifically, although the opening of the well in the chamber of the example 1 is opened in the direction in which the particle settles, the cell captured in the well did not easily fall naturally.

As described above, in the chamber of the example 1, it is not necessary to perform suction for holding the cells in the wells after cell capturing. Damage is accumulated on the cell while a suction force is applied to the cell. Therefore, since it is not necessary to perform suction while observing the cells captured in the wells, damage by the suction force is not accumulated on the cells, and the cells captured in the wells can be observed. Further, since no damage is accumulated on the cells captured in the wells, it is possible to observe the cells for a longer time as compared with the case of observing the cells while performing suction.

### c. Particle Removing

After the b. Cell Capturing, the cells that have settled on the bottom surface of the chamber were discharged to the outside of the chamber. Prior to the discharge, first, the valve 516 was opened and the valve 515 was closed. Specifically, by closing the valve 515, the suction of the cells to the side opposite to the side on which the cells settle using the pump 512 was not performed during the discharge. For the discharge, suction of 1 kPa using the pump 514 was performed. As a result, the cells that have settled on the bottom surface of the chamber were discharge to the outside of the chamber via the fluid discharge channel unit 510.

As described above, in the chamber of the example 1, the cells that are not captured in the wells settle on the bottom surface of the chamber distant from the particle capturing surface including the wells. Therefore, the particles that are not captured in the wells are more easily discharged to the outside of the chamber as compared with the case of the chamber of the comparative example 1.

Further, in the chamber of the example 1, the distance between the cell captured in the well and the cell that has settled on the bottom surface of the chamber is at least approximately 0.3 mm. Therefore, in the case of observing the cells captured in the wells by using the inverted microscope 524, the cells that have settled on the bottom surface of the chamber are significantly out of focus due to the distance. Therefore, the cells that have settled on the bottom surface of the chamber do not interfere with the microscopic observation of the cells captured in the wells in some cases. Therefore, it is also possible to perform the microscopic observation without discharging the cells that have settled on the bottom surface of the chamber from the chamber. Further, it is also possible to omit the mechanism for discharging the cells that have settled on the bottom surface of the chamber from the chamber. As a result, the apparatus can be simplified.

### d. Particle Collection

After the c. Particle Removing, the cells captured in the wells were collected. Prior to the collection, first, the valve 516 was closed. Then, the valve 515 was opened, and differential pressure of 2 kPa was applied by the pump 512 contrary to the pressure in the case of the suction to the side opposite to the side on which the cell settles. As a result, the cells in the wells got out of the wells and returned to the container 523. The cells that have returned to the container 523 can be collected by using an apparatus such as a syringe.

### (3) Example 2

As described in “b. Particle Capturing” of the Example 1, by applying pressure equal to or higher than a predetermined suction pressure, the cells float in the chamber according to the embodiment of the present disclosure. Further, in the chamber according to the embodiment of the present disclosure, it takes a predetermined time for the cells to float from the bottom surface of the chamber and to be captured in the wells. The cells that are not captured in the wells settle on the bottom surface of the chamber. Therefore, it is possible to capture only desired cells in the wells by controlling the suction pressure and/or suction time.

For example, according to the chamber according to the embodiment of the present disclosure, it is possible to capture only cells having a diameter of not less than a predetermined value or cells having a density of not more than a predetermined value in the wells. Alternatively, according to the chamber according to the embodiment of the present disclosure, it is possible to capture only target cells in the wells without capturing foreign matters mixed in the fluid containing cells or a cell aggregate to which a plurality of cells are adhered in the wells.

As described above, according to the chamber according to the embodiment of the present disclosure, it is possible to perform filtering of particles.

In the following, the possibility of particle filtering was verified by obtaining, by simulation, the suction pressure necessary for the particles to float and the time for the particles to be captured in the wells.

In the case where the Reynolds number is sufficiently low, a particle settling velocity follows the following Stokes equation.

Vf=g·Dp2·(ρp−ρf)/18μ

(in the equation, g: gravity acceleration, Dp: particle diameter, ρp: particle density, ρf: Fluid density, μ: viscosity coefficient of fluid)

According to the equation, the specific gravity and diameter of the particle affects the settling velocity. In particular, since the diameter is squared in the equation, the influence thereof is large. In this regard, the suction pressure necessary for the particles with various diameters to float and the time for the particles to be captured in the wells were simulated.

The simulation was performed using COMSOL Multiphysics. In the simulation, one well having the shape as used in the Example 1 was provided vertically above 0.3 mm from the bottom surface of the chamber with the opening of the well facing the bottom surface, and it was assumed that the particle went straight from the bottom surface of the chamber to the well. The particle density of the particle was set to 1.05 g/cm3 close to that of K562 cell used in the Example 1. Particles with four diameters of 10 μm, 15 μm, 20 μm, and 30 μm were simulated, and the suction pressure necessary for the particles to float and the time for the particles to be captured in the wells were obtained. The simulation results are shown in the following Table 4.

TABLE 4

| | Suction pressure | | |
|---|---|---|---|
| | under which | Suction pressure | |
| | particles neither | under which | Time (second) |
| Particle | float nor settle | particles float | necessary for |
| diameter | (Pa) | (Pa) | capturing |
| 10 um | 6 | 7 | 7 |
| 15 um | 16 | 17 | 7.4 |
| 20 um | 29 | 30 | 9 |
| 30 um | 71 | 72 | 17.1 |

As shown in Table 4, for example, the time necessary for capturing the cells with a particle size of 15 μm in the wells was 7.4 seconds while it took 17.1 seconds to capture the particles with a particle size of 30 μm in the wells.

Further, as shown in Table 4, for example, although the particles with a particle size of 10 μm floated by suction pressure of 7 Pa, the particles with a particle size of 15 m did not float by suction pressure of 7 Pa.

As described above, by controlling the suction time or suction pressure, it is possible to capture only the particles with a particles size of not more than a predetermined value in the wells. Further, by controlling the suction time or suction pressure, it is also possible to capture only desired cells without capturing foreign matters having a large shape or a large specific gravity or an aggregate to which a plurality of cells are attached in the wells.

Further, according to the Stokes equation, also the specific gravity of the particle affects the settling velocity. Therefore, by controlling the suction time or suction pressure, it is also possible to capture only particles with a specific gravity not more than a predetermined value in the wells.

For example, in the particle capturing step of the particle capturing method according to the embodiment of the present disclosure, suction is performed with a suction force by which only particles with a size smaller than a predetermined size float.

Further, in the particle capturing step of the particle capturing method according to the embodiment of the present disclosure, the suction force can be changed so that floating of the particles is stopped after a predetermined time has elapsed, or particles that are not captured in the wells can be removed after a predetermined time has elapsed.

It should be noted that the present technology can take the following configurations.

[1] A particle capturing chamber, including at least:

a particle capturing unit including one of at least one well or at least one through hole; and

a particle capturing channel unit used for capturing a particle in the well or with the through hole, in which

the particle is captured in the well or with the through hole by being sucked, via the particle capturing channel unit, to a side opposite to a side on which the particle settles.

[2] The particle capturing chamber according to [1], in which

the well includes a hole, and

the well and the particle capturing channel unit are communicated with each other via the hole.

[3] The particle capturing chamber according to [2], in which

the hole is provided at a bottom of the well.

[4] The particle capturing chamber according to any one of [1] to [3], in which

the well is opened to the side on which the particle settles.

[5] The particle capturing chamber according to any one of [1] to [4], in which
the at least one well includes a plurality of wells, and
each of the wells has such a shape that captures one particle.

[6] The particle capturing chamber according to any one of [1] to [5], in which
the at least one well includes a plurality of wells,
the at least one through hole includes a plurality of through holes, and
the wells or the through holes are regularly arranged on at least one surface of the particle capturing unit.

[7] The particle capturing chamber according to any one of [1] to [6], in which

the particle capturing unit is disposed to divide an inside of the chamber into a space on the side on which the particle settles and a space on the side opposite to the side on which the particle settles.

[8] The particle capturing chamber according to any one of [1] to [7], in which

the particle capturing unit has a particle capturing surface facing the side on which the particle settles, and

the particle capturing surface includes the well or the through hole.

[9] The particle capturing chamber according to [2] or [3], in which

the particle capturing unit has a surface facing the side opposite to the side on which

the particle settles, and

the hole communicates with the surface.

[10] The particle capturing chamber according to any one of [1] to [9], in which the particle capturing unit includes a plate-like part having a particle capturing surface facing the side on which the particle settles and a surface facing the side opposite to the side on which the particle settles.

[11] The particle capturing chamber according to any one of [1] to [10], in which the particle capturing unit is replaceable.

[12] The particle capturing chamber according to any one of [2], [3] and [9], in which the particle capturing unit is disposed to divide an inside of the chamber into a space on the side on which the particle settles and a space on the side opposite to the side on which the particle settles, and the two spaces are communicated with each other via the hole.

[13] The particle capturing chamber according to any one of [1] to [12], in which the particle capturing channel unit is connected to a sucking unit.

[14] The particle capturing chamber according to [7], in which the particle capturing channel unit is connected to the space on the side opposite to the side on which the particle settles.

[15] The particle capturing chamber according to any one of [1] to [14], in which the particle capturing channel unit is further used for discharging the particle captured in the well from the well or discharging the particle captured with the through hole from the through hole.

[16] The particle capturing chamber according to [7] or [14], further including a fluid supply channel unit that supplies fluid containing particles to the chamber, and the fluid supply channel unit is connected to the space on the side on which the particle settles.

[17] The particle capturing chamber according to any one of [7], [14] and [16], further including

a fluid discharge channel unit that discharges fluid from the chamber, and the fluid discharge channel unit is connected to the space on the side on which the particle settles.

[18] The particle capturing chamber according to [17], in which the fluid discharge channel unit is used for discharging a particle that is not captured in the well or with the through hole, and/or collecting the particle captured in the well or with the through hole.

[19] The particle capturing chamber according to any one of [1] to [18], in which at least a part of the particle capturing chamber is formed of a transparent material.

[20] The particle capturing chamber according to [8], in which the particle capturing surface has a staircase shape, or the particle capturing surface is located to form an angle of less than 90 degrees with respect to a direction in which the particle settles.

[21] The particle capturing chamber according to any one of [7] to [20], in which a second fluid supply channel unit is connected to the space on the side opposite to the side on which the particle settles.

[22] A particle capturing chip, including:

one of at least one well or at least one through hole, the particle capturing chip being used for capturing a particle in the well or with the through hole by sucking the particle to a side opposite to a side on which the particle settles, in a particle capturing chamber.

[23] A particle capturing method, including:

capturing a particle in a well or with a through hole by sucking the particle to a side opposite to a side on which the particle settles.

[24] The particle capturing method according to [23], in which the capturing is performed in a particle capturing chamber including at least

a particle capturing unit including one of at least one well or at least one through hole, and

a particle capturing channel unit used for capturing a particle in the well or with the through hole, and

the suction is performed via the particle capturing channel unit.

[25] The particle capturing method according to [23] or [24], further including removing a particle that is not captured in the well or with the through hole.

[26] The particle capturing method according to any one of [23] to [25], further including collecting the particle captured in the well or with the through hole.

[27] The particle capturing method according to any one of [23] to [26], further including

removing, after the capturing, a particle that is not captured in the well or with the through hole, and

collecting, after the removing, the particle captured in the well or with the through hole.

[28] The particle capturing method according to any one of [23] to [27] further including analyzing the particle captured in the well or with the through hole.

[29] The particle capturing method according to [28], in which the analyzing is performed where a suction force smaller than a suction force applied in the capturing is applied or no suction is performed.

[30] The particle capturing method according to any one of [23] to [29], in which in the capturing, the suction is performed with a suction force, only a particle of a size smaller than a predetermined size floating by the suction force.

[31] The particle capturing method according to any one of [23] to [30], in which in the capturing, a suction force is changed after a predetermined time has elapsed, floating of the particle being stopped by the change of the suction force, or a particle that is not captured in the well or with the through hole is removed after a predetermined time has elapsed.

[32] The particle capturing method according to any one of [23] to [31], further including replacing fluid in the particle capturing chamber.

[33] An apparatus, including:

a particle capturing chamber including at least

a particle capturing unit including one of at least one well or at least one through hole, and

a particle capturing channel unit used for capturing a particle in the well or with the through hole; and

a sucking unit that performs suction via the particle capturing channel unit, in which

the particle capturing chamber is configured to capture the particle in the well or with

the through hole by sucking the particle to the side opposite to the side on which the particle settles.

[34] A particle analysis system, including:

a particle capturing chamber including at least

a particle capturing unit including one of at least one well or at least one through hole, and

a particle capturing channel unit used for capturing a particle in the well or with the through hole;

a sucking unit that performs suction via the particle capturing channel unit; and an analysis unit that analyzes the particle captured by the chamber, in which the particle capturing chamber is configured to capture the particle in the well or with the through hole by sucking the particle to the side opposite to the side on which the particle settles.

It should be noted that the present technology can take the following configurations.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100, 500 particle capturing chamber
101, 501 particle capturing unit
102, 508 particle capturing channel unit
103, 509 fluid supply channel unit
106, 525 well
108, 505 hole
510 fluid discharge channel unit

1. A method of separating particles, the method comprising:
applying fluid pressure through a particle capturing chamber, the particle capturing chamber comprising a particle capturing unit dividing the particle capturing chamber into at least a first chamber and a second chamber and comprising a plurality of wells connected to the first chamber each including at least one through hole connected to the second chamber,
wherein the fluid pressure is applied from the first chamber through the through holes of the plurality of wells and into the second chamber, thereby producing fluid flow in a first direction within the through holes, and
wherein at least one force acts upon the particle capturing chamber in a direction that at least partially opposes the first direction.

2. The method of claim 1, wherein the second chamber is arranged above the first chamber, and wherein the at least one force includes a settling force.

3. The method of claim 1, wherein the at least one force includes one or more of: gravity, a centrifugal force produced by rotation of the particle capturing chamber and an electromagnetic force produced by an electric field.

4. The method of claim 1, wherein applying the fluid pressure comprises applying a differential pressure between an inlet and an outlet of the particle capturing chamber.

5. The method of claim 1, further comprising a step of supplying a fluid comprising particles into the first chamber of the particle capturing chamber and capturing particles of the fluid in one or more wells of the plurality of wells.

6. The method of claim 5, further comprising supplying a reagent fluid into the first chamber of the particle capturing chamber, thereby bringing the reagent fluid into contact with at least some of the captured particles in the one or more wells.

7. The method of claim 5, wherein the fluid pressure applied from the first chamber through the through holes of the plurality of wells and into the second chamber is a first fluid pressure, and wherein the method further comprises analyzing the captured particles in the one or more wells whilst applying a second fluid pressure from the first chamber through the through holes of the plurality of wells and into the second chamber, the second fluid pressure being lower than the first fluid pressure.

8. The method of claim 1, further comprising, subsequent to the step of applying fluid pressure from the first chamber through the through holes of the plurality of wells and into the second chamber, ceasing applying said fluid pressure and discharging fluid from the first chamber via a fluid discharge channel.

9. The method of claim 8, further comprising applying suction to the wells from the second chamber during said discharge of fluid from the first chamber via the fluid discharge channel, thereby holding particles in the wells during said discharge.

10. The method of claim 1, wherein the direction of the at least one force forms an angle of at least 160 degrees with the first direction.

11. The method of claim 1, wherein the fluid pressure applied from the first chamber through the through holes of the plurality of wells and into the second chamber is applied for a predetermined amount of time, the predetermined amount of time being selected based on a diameter of particles to be captured within the plurality of wells.

12. A microfluidic device for separating particles, the microfluidic device comprising:
a particle capturing chamber comprising:
a particle capturing unit dividing the particle capturing chamber into at least an upper chamber and a lower chamber and comprising a plurality of wells connected to the lower chamber each including at least one through hole connected to the upper chamber; and
at least one fluid port configured to receive fluid into the lower chamber and direct the fluid through the through holes of the plurality of wells into the upper chamber, thereby producing fluid flow in a first direction within the through holes,
wherein the particle capturing chamber is configured to be oriented during operation of the microfluidic device to separate particles such that there is at least one force acting upon the particle capturing chamber in a direction that at least partially opposes the first direction.

13. The microfluidic device of claim 12, wherein the at least one force includes a settling force.

14. The microfluidic device of claim 13, wherein the settling force is selected from the group consisting of gravity, a centrifugal force produced by a rotation of the particle capturing chamber and an electromagnetic force produced by an electric field.

15. The microfluidic device of claim 12, wherein the plurality of wells are arranged on a side of the particle capturing unit facing the first chamber.

16. The microfluidic device of claim 15, wherein each of the plurality of wells has an opening facing the first chamber and an interior surface through which a respective through hole is formed, and wherein the opening is wider than the through hole.

17. The microfluidic device of claim 12, wherein the through holes of the plurality of wells have a width between 1 μm and 10 μm.

18. The microfluidic device of claim 12, wherein the direction of the at least one force forms an angle of at least 160 degrees with the first direction.

19. A microfluidic system for separating particles, the microfluidic system comprising:
a particle capturing chamber comprising:
a particle capturing unit dividing the particle capturing chamber into at least an upper chamber and a lower chamber and comprising a plurality of wells connected to the lower chamber each including at least one through hole connected to the upper chamber; and
at least one fluid port configured to receive fluid into the lower chamber and direct the fluid through the through holes of the plurality of wells into the upper chamber, thereby producing fluid flow in a first direction within the through holes,
wherein the particle capturing chamber is configured to be oriented during operation of the microfluidic system to separate particles such that there is at least one force acting upon the particle capturing chamber in a direction that at least partially opposes the first direction; and
at least one pressure source coupled to the at least one fluid port and configured to apply fluid pressure to fluid within the lower chamber.

20. The microfluidic system of claim 19, wherein the at least one force comprises one or more of: gravity, a centrifugal force produced by a rotation of the particle capturing chamber and an electromagnetic force produced by an electric field.
